(19) United States
(12) Patent Application Publication
(10) Pub. No.: US 2022/0101878 A1
(43) Pub. Date: Mar. 31, 2022

(54) HOLOGRAM RECORDING COMPOSITION, HOLOGRAM RECORDING MEDIUM, HOLOGRAM, AND OPTICAL DEVICE AND OPTICAL COMPONENT USING SAME

(71) Applicant: SONY GROUP CORPORATION, TOKYO (JP)

(72) Inventors: TAKAHIRO OHE, TOKYO (JP); HISAYA HARA, TOKYO (JP); KENSHIRO KAWASAKI, TOKYO (JP); ERI IGARASHI, TOKYO (JP)

(21) Appl. No.: 17/424,950

(22) PCT Filed: Jan. 29, 2020
(86) PCT No.: PCT/JP2020/003161

§ 371 Date: Jul. 22, 2021

(30) Foreign Application Priority Data
Jan. 31, 2019 (JP) 2019-015912

(51) Int. Cl. G11B 7/24044; G11B 7/245; G03H 1/02; G11B 7/0065; C08F 2/44; C08F 2/50

(52) U.S. Cl. CPC G11B 7/24044; G11B 7/245; G03H 1/024; G03H 2001/0264; C08F 2/44; C08F 2/50; G03H 2260/12; G11B 7/0065

(57) ABSTRACT

To provide a hologram recording composition capable of further improving diffraction characteristics.

The present technology provides a hologram recording composition containing at least a radically polymerizable monomer, a matrix resin, a photopolymerization initiator, and an anthracene-based compound. The present technology also provides a hologram recording medium including a photocurable resin layer containing at least a radically polymerizable monomer, a matrix resin, a photopolymerization initiator, and an anthracene-based compound. Furthermore, the present technology also provides a hologram using the hologram recording medium. Moreover, the present technology also provides an optical device and an optical component using the hologram.

### TECHNICAL FIELD

The present technology relates to a hologram recording composition, a hologram recording medium, a hologram, and an optical device and an optical component using the same.

### BACKGROUND ART

A hologram is obtained by recording a light-dark (interference) pattern of light on a photosensitive material and the like as a pattern of a refractive index and the like, and is widely used in a field such as optical information processing, security, medicine, or a head-up display. The hologram is attracting attention as a next-generation recording medium because of being able to record three-dimensional information about an object as optical information in a large capacity.

So far, various proposals have been made for materials for the hologram. For example, Patent Document 1 proposes a photosensitive material containing a polymer matrix formed by radical polymerization of a radically polymerizable compound in the presence of a radical polymerization initiator, a photocationic polymerization initiator, and a cationically polymerizable compound, and characterized in that a reduction potential of the photocationic polymerization initiator is lower than an oxidation potential of radicals generated from the radical polymerization initiator.

### CITATION LIST

### Patent Document

Patent Document 1: Japanese Patent Application Laid-Open No. 2010-210654

### SUMMARY OF THE INVENTION

### Problems to be Solved by the Invention

However, in hologram technology, it is required to further improve diffraction characteristics. Therefore, a main object of the present technology is to provide a hologram recording composition, a hologram recording medium, a hologram, and an optical device and an optical component using the same, which can further improve the diffraction characteristics.

### Solutions to Problems

The present inventors made intensive studies in order to solve the above-described problem, and as a result, have succeeded in further improving diffraction characteristics, and have completed the present technology.

That is, the present technology provides a hologram recording composition containing at least a radically polymerizable monomer, a matrix resin, a photopolymerization initiator, and an anthracene-based compound.

The hologram recording composition according to the present technology may contain a monofunctional monomer and a polyfunctional monomer as the radically polymerizable monomer.

In the hologram recording composition according to the present technology, the radically polymerizable monomer may have a refractive index of 1.6 or more.

In the hologram recording composition according to the present technology, the radically polymerizable monomer may be at least one selected from the group consisting of a carbazole-based monomer, a fluorene-based monomer, and a dinaphthothiophene-based monomer.

In the hologram recording composition according to the present technology, the radically polymerizable monomer may be a compound represented by the following general formula (1-10).

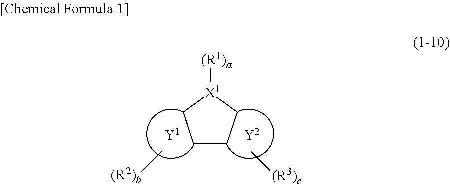

(In the general formula (1-10), X¹ is an oxygen atom, a nitrogen atom, a phosphorus atom, a carbon atom, or a silicon atom. In a case where X¹ is an oxygen atom, a is 0. In a case where X¹ is a nitrogen atom or a phosphorus atom, a is 1. In a case where X¹ is a carbon atom or a silicon atom, a is 2.

Y¹ and Y² are each a benzene ring or a naphthalene ring, and Y¹ and Y² are not both benzene rings at the same time. In a case where Y¹ or Y² is a benzene ring, b or c corresponding to the benzene ring Y¹ or Y² is 4. In a case where Y¹ and/or Y² is a naphthalene ring, b and/or c corresponding to the naphthalene ring Y¹ and/or Y² is 6.

R¹ to R³ are each a hydrogen atom or a substituent represented by *—Z¹(R⁴)_{d} (* represents a bond position). In a case where a plurality of R¹s, a plurality of Res, and a plurality of R³s are present, the plurality of R¹s to R³s may be the same as or different from each other. However, R¹s to R³s in the general formula (1-10) are not all hydrogen atoms at the same time.

Z¹ represents a single bond, a divalent or higher valent saturated hydrocarbon group, or a divalent or higher valent unsaturated hydrocarbon group, and the saturated hydrocarbon group or the unsaturated hydrocarbon group may contain an ether bond and/or a thioether bond. In a case where Z¹ is a single bond, d is 1. In a case where Z¹ is a saturated hydrocarbon group or an unsaturated hydrocarbon group, d is an integer equal to or larger than 1.

R⁴ represents a hydrogen atom or a polymerizable substituent. In a case where a plurality of R⁴s is present, the plurality of R⁴s may be the same as or different from each other. However, R⁴s in the general formula (1-10) are not all hydrogen atoms at the same time.)

Furthermore, the hologram recording composition may further contain inorganic fine particles.

The hologram recording composition may further contain a cationically polymerizable compound.

In the hologram recording composition according to the present technology, the cationically polymerizable compound may be at least one selected from the group consisting of an epoxy compound and an oxetane compound.

The hologram recording composition may further contain a polymerization inhibitor.

Furthermore, the present technology also provides a hologram recording medium including a photocurable resin layer containing at least a radically polymerizable monomer, a matrix resin, a photopolymerization initiator, and an anthracene-based compound.

The hologram recording medium according to the present technology may contain a monofunctional monomer and a polyfunctional monomer as the radically polymerizable monomer.

In the hologram recording medium according to the present technology, the radically polymerizable monomer may have a refractive index of 1.6 or more.

In the hologram recording medium according to the present technology, the radically polymerizable monomer may be at least one selected from the group consisting of a carbazole-based monomer, a fluorene-based monomer, and a dinaphthothiophene-based monomer.

In the hologram recording medium according to the present technology, the radically polymerizable monomer may be a compound represented by the following general formula (1-10).

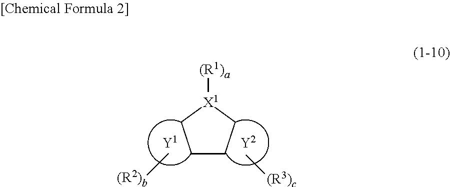

(In the general formula (1-10), X¹ is an oxygen atom, a nitrogen atom, a phosphorus atom, a carbon atom, or a silicon atom. In a case where X¹ is an oxygen atom, a is 0. In a case where X¹ is a nitrogen atom or a phosphorus atom, a is 1. In a case where X¹ is a carbon atom or a silicon atom, a is 2.

Y¹ and Y² are each a benzene ring or a naphthalene ring, and Y¹ and Y² are not both benzene rings at the same time. In a case where Y¹ or Y² is a benzene ring, b or c corresponding to the benzene ring Y¹ or Y² is 4. In a case where Y¹ and/or Y² is a naphthalene ring, b and/or c corresponding to the naphthalene ring Y¹ and/or Y² is 6.

R¹ to R³ are each a hydrogen atom or a substituent represented by *—Z¹(R⁴)_{d} (* represents a bond position). In a case where a plurality of R¹s, a plurality of Res, and a plurality of R³s are present, the plurality of R¹s to R³s may be the same as or different from each other. However, R¹s to R³s in the general formula (1-10) are not all hydrogen atoms at the same time.

Z¹ represents a single bond, a divalent or higher valent saturated hydrocarbon group, or a divalent or higher valent unsaturated hydrocarbon group, and the saturated hydrocarbon group or the unsaturated hydrocarbon group may contain an ether bond and/or a thioether bond. In a case where Z¹ is a single bond, d is 1. In a case where Z¹ is a saturated hydrocarbon group or an unsaturated hydrocarbon group, d is an integer equal to or larger than 1.

R⁴ represents a hydrogen atom or a polymerizable substituent. In a case where a plurality of R⁴s is present, the plurality of R⁴s may be the same as or different from each other. However, R⁴s in the general formula (1-10) are not all hydrogen atoms at the same time.)

Furthermore, the hologram recording medium according to the present technology may further contain inorganic fine particles.

The hologram recording medium according to the present technology may further contain a cationically polymerizable compound.

In the hologram recording medium according to the present technology, the cationically polymerizable compound may be at least one selected from the group consisting of an epoxy compound and an oxetane compound.

The hologram recording medium according to the present technology may further contain a polymerization inhibitor.

Moreover, the present technology also provides a hologram using the hologram recording medium according to the present technology.

The hologram according to the present technology may have absorption derived from an anthracene skeleton.

The present technology also provides an optical device using the hologram according to the present technology, and also provides an optical component using the hologram according to the present technology.

### BRIEF DESCRIPTION OF DRAWINGS

FIG. 1 is a diagram schematically illustrating absorption derived from an anthracene skeleton.

FIG. 2 is a cross-sectional view schematically illustrating an example of a hologram recording medium according to an embodiment of the present technology.

### MODE FOR CARRYING OUT THE INVENTION

Hereinafter, a preferable embodiment for carrying out the present technology will be described. Note that the embodiments described below exemplify typical embodiments of the present technology, and the scope of the present technology is not limited to the embodiments.

Note that the present technology will be described in the following order.

1. Summary of the present technology

2. First embodiment (hologram recording composition)

2-1. Hologram recording composition

2-2. Radically polymerizable monomer

2-3. Matrix resin

2-4. Photopolymerization initiator

2-5. Anthracene-based compound

2-6. Inorganic fine particles

2-7. Plasticizer

2-8. Polymerization inhibitor

2-9. Other components

2-10. Method for manufacturing hologram recording composition

3. Second embodiment (hologram recording medium)

3-1. Hologram recording medium

3-2. Photocurable resin layer

3-3. Transparent base material

3-4. Method for manufacturing hologram recording medium

4. Third embodiment (hologram)

4-1. Hologram

4-2. Method for manufacturing hologram

5. Fourth embodiment (optical device and optical component)

### 1. Summary of the Present Technology

First, summary of the present technology will be described.

The present technology relates to a hologram recording composition, a hologram recording medium, a hologram, and an optical device and an optical component using the same.

So far, in order to obtain a hologram having a high refractive index modulation amount (Δn), it has been indispensable to go through a heating step after interference exposure, which has been a factor in complicating a process.

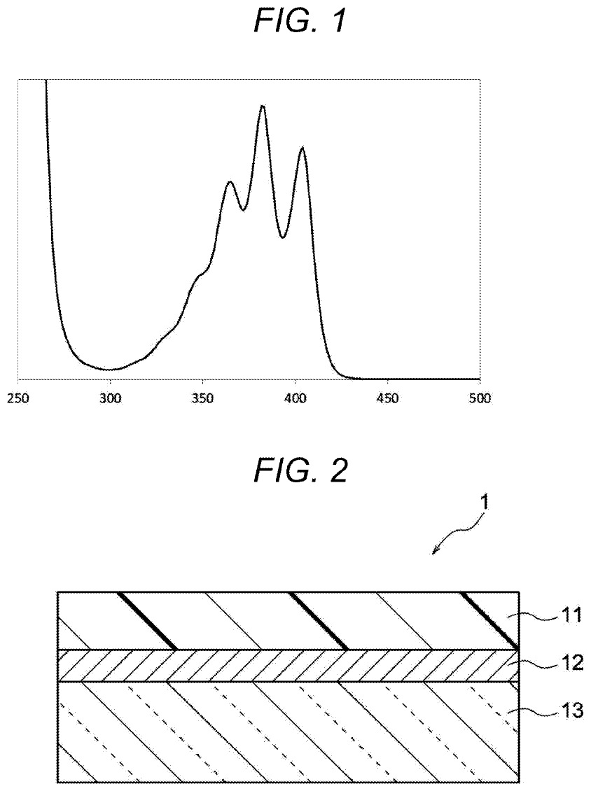

As a result of various studies, the present inventors have found that a reaction rate of a polymerization reaction occurring in a bright part during interference exposure can be controlled by using an anthracene-based compound as a material for a hologram, as a result, refractive index modulation is promoted, and the refractive index modulation amount (Δn) is increased. Furthermore, the present inventors have also found that the anthracene-based compound has a specific absorption region derived from an anthracene skeleton on a long wavelength side (around 350 nm to 400 nm) as illustrated in FIG. 1, therefore has high UV absorption efficiency, can improve UV energy utilization efficiency in a UV irradiation step, can suppress UV irradiation on a substance that is yellowed by UV, and therefore can suppress yellowing of a hologram.

That is, by combining a radically polymerizable monomer, a matrix resin, a photopolymerization initiator, and an anthracene-based compound as materials for a hologram, the present technology can provide a hologram recording composition, a hologram recording medium, a hologram, and an optical device and an optical component using the same, having excellent diffraction characteristics without going through a heating step after exposure. Furthermore, the combination can also provide a hologram recording composition, a hologram recording medium, a hologram, and an optical device and an optical component using the same, having excellent transparency.

### 2. First Embodiment (Hologram Recording Composition)

### [2-1. Hologram Recording Composition]

A hologram recording composition according to a first embodiment of the present technology is a hologram recording composition containing at least a radically polymerizable monomer, a matrix resin, a photopolymerization initiator, and an anthracene-based compound.

The hologram recording composition according to the first embodiment of the present technology can provide a hologram having a high refractive index modulation amount (Δn) without going through a heating step after exposure. Furthermore, the hologram recording composition can make the transparency of the hologram favorable. Hereinafter, each component will be described in detail.

### [2-2. Radically Polymerizable Monomer]

The hologram recording composition according to the present embodiment contains a radically polymerizable monomer. The radically polymerizable monomer in the present embodiment preferably contains at least two radically polymerizable monomers, and more preferably further contains a monofunctional monomer and a polyfunctional monomer.

The radically polymerizable monomer in the present embodiment preferably has a refractive index of 1.6 or more from a viewpoint of making the diffraction characteristics of an obtained hologram favorable. Note that the refractive index can be measured by a critical angle method or a spectroscopic ellipsometry method. For example, in the critical angle method, the refractive index can be measured using an Abbe refractive index meter ER-1 manufactured by Erma Inc. (measurement is performed using a measurement wavelength such as 486 nm, 589 nm, or 656 nm in a visible light region).

The radically polymerizable monomer in the present embodiment is preferably at least one selected from the group consisting of a carbazole-based monomer, a fluorene-based monomer, and a dinaphthothiophene-based monomer.

In a preferable aspect, the hologram recording composition according to the present embodiment contains at least a monofunctional carbazole-based monomer and a polyfunctional fluorene-based monomer. In addition, the polyfunctional fluorene-based monomer is preferably a bifunctional fluorene-based monomer.

The monofunctional carbazole-based monomer is preferably a compound represented by the following general formula (1).

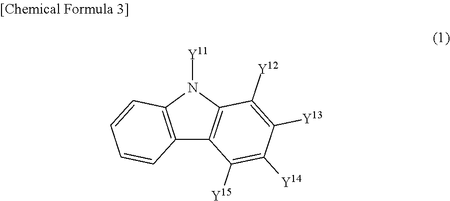

In the above formula (1), only one of Y¹¹ to Y¹⁵ is one of substituents represented by the following general formulas (2-1) to (2-7). Note that in a case where any two or more of Y¹¹ to Y¹⁵ are two or more of the substituents represented by the following general formulas (2-1) to (2-7), the compound represented by general formula (1) is a polyfunctional (bifunctional or higher functional) carbazole-based monomer.

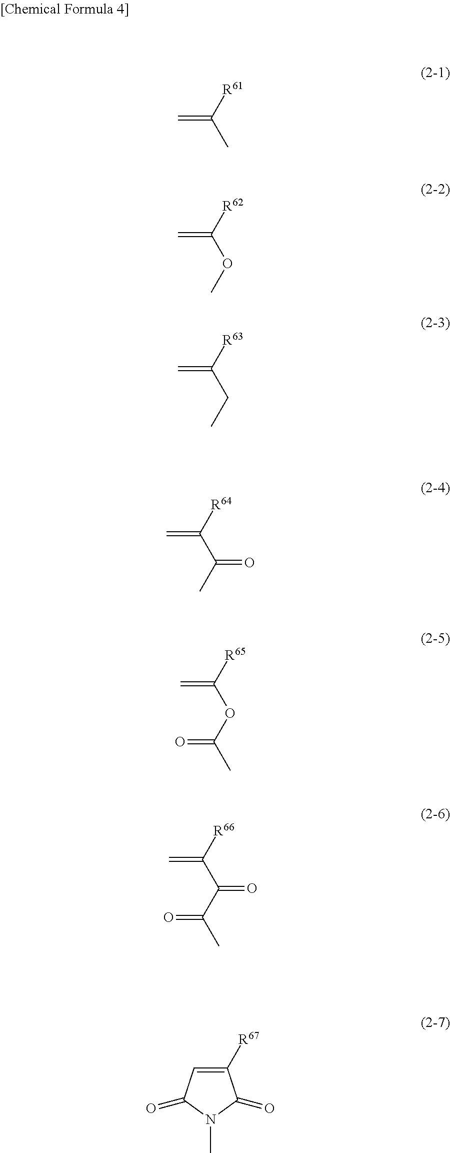

Y¹¹ to Y¹⁵ (excluding at least one of Y¹¹ to Y¹⁵, which is at least one of the substituents represented by the above general formulas (2-1) to (2-7)) and R⁶¹ to R⁶⁷ can be each independently, for example, an alkyl group (a methyl group, an ethyl group, a propyl group, an isopropyl group, a t-butyl group, a pentyl group, a hexyl group, an octyl group, a dodecyl group, a trifluoromethyl group, and the like); a cycloalkyl group (a cyclopentyl group, a cyclohexyl group, and the like); an aryl group (a phenyl group, a naphthyl group, and the like); an acylamino group (an acetylamino group, a benzoylamino group, and the like); an alkylthio group (a methylthio group, an ethylthio group, and the like); an arylthio group (a phenylthio group, a naphthylthio group, and the like); an alkenyl group (a vinyl group, a 2-propenyl group, a 3-butenyl group, a 1-methyl-3-propenyl group, a 3-pentenyl group, a 1-methyl-3-butenyl group, a 4-hexenyl group, a cyclohexenyl group, and the like); a halogen atom (a fluorine atom, a chlorine atom, a bromine atom, an iodine atom, and the like); an alkynyl group (a propargyl group and the like); a heterocyclic group (a pyridyl group, a thiazolyl group, an oxazolyl group, an imidazolyl group, and the like); an alkylsulfonyl group (a methylsulfonyl group, an ethylsulfonyl group, and the like); an arylsulfonyl group (a phenylsulfonyl group, a naphthylsulfonyl group, and the like); an alkylsulfinyl group (a methylsulfinyl group and the like); an arylsulfinyl group (a phenylsulfinyl group and the like); a phosphono group; an acyl group (an acetyl group, a pivaloyl group, a benzoyl group, and the like); a carbamoyl group (an aminocarbonyl group, a methylaminocarbonyl group, a dimethylaminocarbonyl group, a butylaminocarbonyl group, a cyclohexylaminocarbonyl group, a phenylaminocarbonyl group, a 2-pyridylaminocarbonyl group, and the like); a sulfamoyl group (an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group, a 2-pyridylaminosulfonyl group, and the like); a sulfonamide group (a methanesulfonamide group, a benzenesulfonamide group, and the like); a cyano group; an alkoxy group (a methoxy group, an ethoxy group, a propoxy group, and the like); an aryloxy group (a phenoxy group, a naphthyloxy group, and the like); a heterocyclic oxy group; a siloxy group; an acyloxy group (an acetyloxy group, a benzoyloxy group, and the like); a sulfonic acid group; a sulfonate; an aminocarbonyloxy group; an amino group (an amino group, an ethylamino group, a dimethylamino group, a butylamino group, a cyclopentylamino group, a 2-ethylhexylamino group, a dodecylamino group, and the like); an anilino group (a phenylamino group, a chlorophenylamino group, a toluidino group, an anisidino group, a naphthylamino group, a 2-pyridylamino group, and the like); an imide group; a ureido group (a methyl ureido group, an ethyl ureido group, a pentyl ureido group, a cyclohexyl ureido group, an octyl ureido group, a dodecyl ureido group, a phenyl ureido group, a naphthyl ureido group, a 2-pyridyl amino ureido group, and the like); an alkoxycarbonylamino group (a methoxycarbonylamino group, a phenoxycarbonylamino group, and the like); an alkoxycarbonyl group (a methoxycarbonyl group, an ethoxycarbonyl group, a phenoxycarbonyl group, and the like); an aryloxycarbonyl group (a phenoxycarbonyl group and the like); a heterocyclic thio group; a thioureido group; a carboxyl group; a carboxylate; a hydroxyl group; a mercapto group; or a nitro group, but are not limited thereto. Furthermore, each of these groups may have a substituent, and examples of the substituent include similar groups to those described above.

The monofunctional carbazole-based monomer represented by the above general formula (1) can be synthesized by various known synthetic methods, but for example, can be synthesized on the basis of the synthetic method described in Japanese Patent Application Laid-Open No. 2015-105239.

In the present embodiment, among the carbazole-based monomers represented by general formula (1), a carbazole acrylate or an N-vinylcarbazole derivative is preferably used. For example, 2-(9H-carbazol-9-yl) ethyl acrylate (manufactured by SIGMA ALDRICH, refractive index: 1.65) and N-vinylcarbazole (manufactured by Tokyo Chemical Industry Co., Ltd., refractive index: 1.68) are preferably used.

The bifunctional fluorene-based monomer (polyfunctional fluorene-based monomer) is preferably a 9,9-bisarylfluorene, and examples thereof include a compound represented by the following general formula (3).

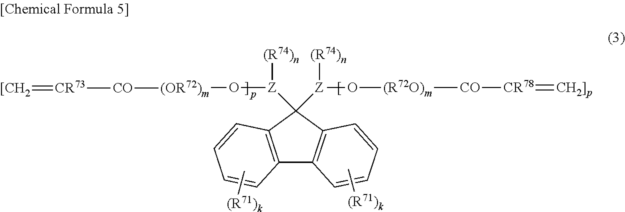

In the above formula (3), a ring Z represents an aromatic hydrocarbon ring, R⁷¹ represents a substituent, R⁷² represents an alkylene group, R⁷³ represents a hydrogen atom or a methyl group, R⁷⁴ represents a substituent, k is an integer of 0 to 4, m is an integer of 0 or more, n is an integer of 0 or more, and p is an integer of 1. Note that in a case where p is 2 or more, the compound represented by general formula (3) is a polyfunctional fluorene-based monomer.

In the above formula (3), examples of the aromatic hydrocarbon ring represented by the ring Z include a benzene ring and a condensed polycyclic arene (or condensed polycyclic aromatic hydrocarbon) ring. Among these rings, examples of the condensed polycyclic arene (or condensed polycyclic aromatic hydrocarbon) ring include condensed bi- to tetra-cyclic arene rings such as a condensed bicyclic arene ring (a C₈₋₂₀ condensed bicyclic arene ring such as an indene ring or a naphthalene ring, preferably a C₁₀₋₁₆ condensed bicyclic arene ring); and a condensed tricyclic arene ring (an anthracene ring, a phenanthrene ring, and the like). Preferable examples of the condensed polycyclic arene ring include a naphthalene ring and an anthracene ring, and a naphthalene ring is more preferable of these rings. Note that the two rings Z in formula (3) may be the same ring or different rings, and usually may be the same ring.

The ring Z is typically a benzene ring or a naphthalene ring, and the ring Z may be a naphthalene ring from a viewpoint of high heat resistance, high refractive index, and the like of a hologram.

In the above formula (3), examples of the group R⁷¹ include a non-reactive substituent such as a cyano group; a halogen atom (a fluorine atom, a chlorine atom, a bromine atom, and the like); or a hydrocarbon group [an alkyl group, an aryl group (a C₆₋₁₀ aryl group such as a phenyl group), and the like], but the group R⁷¹ is preferably a group which is not a halogen atom, such as an alkyl group. Examples of the alkyl group include a C₁₋₁₂ alkyl group such as a methyl group, an ethyl group, a propyl group, an isopropyl group, a butyl group, or a t-butyl group (for example, a C₁₋₈ alkyl group, particularly a C₁₋₄ alkyl group such as a methyl group). Note that in a case where k in formula (3) is plural (2 or more), the groups R⁷¹s may be different from or the same as each other. Furthermore, the groups R⁷¹s to be substituted for the two benzene rings constituting fluorene (or fluorene skeleton) may be the same as or different from each other. Furthermore, bond positions (substitution positions) of the groups R⁷¹s to the benzene rings constituting fluorene are not particularly limited. The substitution number k is preferably 0 or 1, and more preferably 0. Note that the two benzene rings constituting fluorene may have the same substitution number k as each other or different substitution numbers k from each other.

In the above formula (3), examples of the alkylene group represented by the group R⁷² include a C₂₋₆ alkylene group such as an ethylene group, a propylene group, a trimethylene group, a 1,2-butanediyl group, or a tetramethylene group. Preferable examples thereof include a C₂₋₄ alkylene group. More preferable examples thereof include a C₂₋₃ alkylene group. Note that in a case where m in formula (3) is 2 or more, the alkylene groups may be constituted by different alkylene groups, or may be usually constituted by the same alkylene group. Furthermore, in the two rings Z, the groups R⁷²s may be the same as or different from each other, and may be usually the same.

The number (additional mol number) m of the oxyalkylene groups (OR⁷²s) in the above formula (3) can be selected from a range of about 0 to 15 (for example, 0 to 12), and may be, for example, 0 to 8 (for example, 0 to 8), preferably 0 to 6 (for example, 1 to 6), and more preferably 0 to 4 (for example, 1 to 4). In particular, m may be 1 or more (for example, 1 to 4, preferably 1 to 3, more preferably 1 to 2, and particularly 1). Note that different rings Z may have the same substitution number m as each other or different substitution numbers m from each other. Furthermore, in the two rings Z, the total number of oxyalkylene groups (m×2) can be selected from a range of about 0 to 30 (for example, 2 to 24), and may be, for example, 0 to 16 (for example, 2 to 14), preferably 0 to 12 (for example, 2 to 10), more preferably 0 to 8 (for example, 0 to 6), and particularly 0 to 4 (for example, 2 to 4).

In the above formula (3), the substitution number p of the group containing the group R⁷² (also referred to as a (meth)acryloyl group-containing group and the like) is 1, but is 2 or more in a case of a polyfunctional fluorene-based monomer. Note that the different rings Z may have the same substitution number p as each other or different substitution numbers p from each other, and usually often have the same substitution number p. Note that a substitution position of the (meth)acryloyl group-containing group is not particularly limited, and the (meth)acryloyl group-containing group only needs to be substituted at an appropriate substitution position of the ring Z. For example, in a case where the ring Z is a benzene ring, the (meth)acryloyl group-containing group may be substituted at an appropriate position (particularly at least 4-position) among 2- to 6-positions of the benzene ring, and in a case where the ring Z is a condensed polycyclic hydrocarbon ring, the (meth)acryloyl group-containing group may be substituted at least for a hydrocarbon ring (for example, 5-position, 6-position, and the like of a naphthalene ring) different from the hydrocarbon ring bonded to 9-position of fluorene.

In the above formula (3), the substituent R⁷⁴ substituted for the ring Z is usually a non-reactive substituent, and examples thereof include a hydrocarbon group such as an alkyl group (a C₁₋₁₂ alkyl group such as a methyl group, an ethyl group, a propyl group, an isopropyl group, or a butyl group, preferably a C₁₋₈ alkyl group, more preferably a C₁₋₆ alkyl group, and the like), a cycloalkyl group (a C₅₋₈ cycloalkyl group such as a cyclohexyl group, preferably a C₅₋₆ cycloalkyl group, and the like), an aryl group (a C₆₋₁₄ aryl group such as a phenyl group, a tolyl group, a xylyl group, or a naphthyl group, preferably a C₆₋₁₀ aryl group, more preferably a C₆₋₈ aryl group, and the like), or an aralkyl group (a C₆₋₁₀ aryl-C₁₋₄ alkyl group such as a benzyl group or a phenethyl group, and the like); a group-OR⁷⁵ [in which R⁷⁵ represents a hydrocarbon group (the above-exemplified hydrocarbon groups and the like)] such as an alkoxy group (a C₁₋₈ alkoxy group such as a methoxy group or an ethoxy group, preferably a C₁₋₆ alkoxy group, and the like), a cycloalkoxy group (a C₅₋₁₀ cycloalkyloxy group such as a cyclohexyloxy group), an aryloxy group (a C₆₋₁₀ aryloxy group such as a phenoxy group), or an aralkyloxy group (a C₆₋₁₀ aryl-C₁₋₄ alkyloxy group such as a benzyloxy group); a group-SR⁷⁵ (in which R⁷⁵ represents the same as above) such as an alkylthio group (a C₁₋₈ alkylthio group such as a methylthio group or an ethylthio group, preferably a C₁₋₆ alkylthio group, and the like), a cycloalkylthio group (a C₅₋₁₀ cycloalkylthio group such as a cyclohexylthio group, and the like), an arylthio group (a C₆₋₁₀ arylthio group such as a thiophenoxy group), or an aralkylthio group (a C₆₋₁₀ aryl-C₁₋₄ alkylthio group such as a benzylthio group); an acyl group (a C₁₋₆ acyl group such as an acetyl group); an alkoxycarbonyl group (a C₁₋₄ alkoxy-carbonyl group such as a methoxycarbonyl group); a halogen atom (a fluorine atom, a chlorine atom, a bromine atom, an iodine atom, and the like); a nitro group; a cyano group; and a substituted amino group (a dialkylamino group such as a dimethylamino group, and the like).

Preferable examples of the group R⁷⁴ include a hydrocarbon group [an alkyl group (for example, a C₁₋₆ alkyl group), a cycloalkyl group (for example, a C₅₋₈ cycloalkyl group), an aryl group (for example, a C₆₋₁₀ aryl group), an aralkyl group (for example, a C₆₋₈ aryl-C₁₋₂ alkyl group), and the like], and an alkoxy group (for example, a C₁₋₄ alkoxy group). Among these groups, an alkyl group [a C₁₋₄ alkyl group (particularly a methyl group) and the like], an aryl group [a C₆₋₁₀ aryl group (particularly a phenyl group) and the like], and the like are more preferable.

Note that in a case where n in the same ring Z is plural (2 or more), the groups R⁷⁴s may be different from or the same as each other. Furthermore, in the two rings Z, the groups R⁷⁴s may be the same as or different from each other. Furthermore, the preferable substitution number n can be selected according to the type of ring Z, and may be, for example, 0 to 8, preferably 0 to 4 (for example, 0 to 3), and more preferably 0 to 2. Note that different rings Z may have the same substitution number n as each other or different substitution numbers n from each other, and may usually have the same substitution number n.

The bifunctional fluorene-based monomer (polyfunctional fluorene-based monomer) represented by the above general formula (3) can be synthesized by various known synthetic methods, but for example, can be synthesized on the basis of the synthetic method described in Japanese Patent Application Laid-Open No. 2012-111942.

In the present embodiment, as the fluorene-based monomer represented by general formula (3), for example, bisphenoxyethanol fluorene diacrylate (“EA-0200” manufactured by Osaka Gas Chemicals Co., Ltd., refractive index: 1.62) is preferably used.

In a preferable aspect, the hologram recording composition according to the present embodiment contains at least a monofunctional dinaphthothiophene-based monomer and a polyfunctional fluorene-based monomer. In addition, the polyfunctional fluorene-based monomer is preferably a bifunctional fluorene-based monomer.

The monofunctional dinaphthothiophene-based monomer is preferably a compound represented by the following general formula (4).

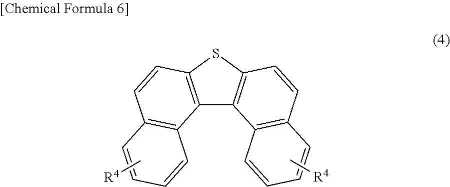

In the above formula (4), R⁴ is a substituent on a benzene ring not condensed with a thiophene ring, and is a hydroxy group, a 2-allyloxy group, a vinyloxy group, a 2,3-epoxypropoxy group, a 2-(meth)acryloyloxy group, a 2-(meth)acryloyloxyethoxy group, an R⁴¹O-group (in which R⁴¹ represents an alkyl group which may contain an oxygen atom or a sulfur atom as a heteroatom), or an HO—X—O— group (in which X represents an alkylene chain or an aralkylene chain which may contain an oxygen atom or a sulfur atom as a heteroatom).

In a case of a monofunctional dinaphthothiophene-based monomer, one of the two R⁴s in the above formula (4) is a group having a polymerizable unsaturated bond. In a case of a bifunctional dinaphthothiophene-based monomer, the two R⁴s in the above formula (4) are each a group having a polymerizable unsaturated bond.

In the above formula, R⁴¹ is an alkyl group which may contain an oxygen atom or a sulfur atom as a heteroatom. R⁴¹ may be, for example, a linear or branched alkyl group having 1 to 20 carbon atoms, and examples thereof include a methyl group, an ethyl group, a propyl group, an isopropyl group, a n-butyl group, an isobutyl group, a sec-butyl group, a tert-butyl group, a 2-ethylhexyl group, a dodecyl group, a cetyl group, a methoxymethyl group, a 2-methoxyethyl group, an ethoxymethyl group, a 2-(ethoxy) ethyl group, and a 2-(methyl mercapto) ethyl group.

Furthermore, X is an alkylene chain or an aralkylene chain which may contain an oxygen atom or a sulfur atom as a heteroatom. The alkylene chain may be, for example, a linear or branched alkylene chain having 1 to 10 carbon atoms, and examples thereof include a methylene group, an ethylene group, a trimethylene group, a tetramethylene group, a hexamethylene group, a decamethylene group, a propylene group, and a cyclohexylene group. Examples of the alkylene chain which may contain a heteroatom of oxygen or sulfur include a polyoxyalkylene chain having oxyethylene or oxypropylene as a repeating unit.

Examples of an alkylene portion of the aralkylene chain which may contain a heteroatom of oxygen or sulfur include the above-described alkylene chain.

The dinaphthothiophene-based monomer represented by the above general formula (4) can be synthesized by various known synthetic methods, but for example, can be synthesized on the basis of the synthetic method described in Japanese Patent Application Laid-Open No. 2014-196288.

In the present embodiment, as the dinaphthothiophene-based monomer represented by general formula (4), for example, dinaphthothiophene methacrylate (“DNTMA” manufactured by Sugai Chemical Industry Co., Ltd., refractive index: 1.89) is preferably used.

In another preferable aspect, the hologram recording composition according to the present embodiment contains at least monofunctional and polyfunctional acrylates or methacrylates and inorganic fine particles described later. In a case where the hologram recording composition contains inorganic fine particles, a radically polymerizable monomer having a low refractive index is preferably used.

Examples of the monofunctional acrylate include an alkyl acrylate (lauryl acrylate, tetradecyl acrylate, stearyl acrylate, isostearyl acrylate, behenyl acrylate, and the like); isobornyl acrylate; methoxypolyethylene glycol acrylate; methoxypolypropylene glycol acrylate; and a benzene ring-containing acrylate (phenoxyethylene glycol acrylate, phenoxydiethylene glycol acrylate, and the like). Furthermore, examples of the monofunctional methacrylate include methacrylates of the above-described compounds.

On the other hand, examples of the polyfunctional acrylate include an alkyl diacrylate (1,6-hexanediol diacrylate, 1,9-nonanediol diacrylate, isononanediol diacrylate, 1,10-decanediol diacrylate, neopentyl glycol diacrylate, and the like); polyethylene glycol diacrylate; dipropylene glycol diacrylate; tripropylene glycol diacrylate; and polytetramethylene glycol diacrylate. Furthermore, examples of the polyfunctional methacrylate include methacrylates of the above-described compounds.

Note that among these compounds, a compound having a refractive index that is not high is preferably used from a viewpoint of combination with inorganic fine particles, and a monomer not having an aromatic structure such as a benzene ring is preferably used. More specifically, a monomer having a (saturated) alkyl or a (saturated) alicyclic hydrocarbon structure is preferably used.

Furthermore, the radically polymerizable monomer in the present embodiment may be a compound represented by the following general formula (1-10). The compound has a high refractive index, and has favorable transparency and solubility in an organic solvent.

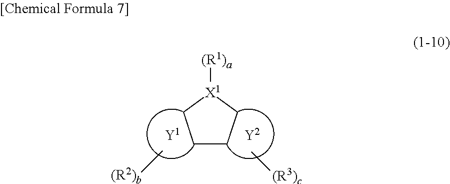

In general formula (1-10), X¹ is an oxygen atom, a nitrogen atom, a phosphorus atom, a carbon atom, or a silicon atom. In a case where X¹ is an oxygen atom, a is 0. In a case where X¹ is a nitrogen atom or a phosphorus atom, a is 1. In a case where X¹ is a carbon atom or a silicon atom, a is 2.

Y¹ and Y² are each a benzene ring or a naphthalene ring, and Y¹ and Y² are not both benzene rings at the same time. In a case where Y¹ or Y² is a benzene ring, b or c corresponding to the benzene ring Y¹ or Y² is 4. In a case where Y¹ and/or Y² is a naphthalene ring, b and/or c corresponding to the naphthalene ring Y¹ and/or Y² is 6.

R¹ to R³ are each a hydrogen atom or a substituent represented by *—Z¹(R⁴)_{d} (* represents a bond position). In a case where a plurality of R¹s, a plurality of R²s, and a plurality of R³s are present, the plurality of R¹s to R³s may be the same as or different from each other. However, R¹s to R³s in general formula (1-10) are not all hydrogen atoms at the same time.

Z¹ represents a single bond, a divalent or higher valent saturated hydrocarbon group, or a divalent or higher valent unsaturated hydrocarbon group, and the saturated hydrocarbon group or the unsaturated hydrocarbon group may contain an ether bond and/or a thioether bond. In a case where Z¹ is a single bond, d is 1. In a case where Z¹ is a saturated hydrocarbon group or an unsaturated hydrocarbon group, d is an integer equal to or larger than 1.

R⁴ represents a hydrogen atom or a polymerizable substituent. In a case where a plurality of R⁴s is present, the plurality of R⁴s may be the same as or different from each other. However, R⁴s in general formula (1-10) are not all hydrogen atoms at the same time.

That is, the compound represented by general formula (1-10) may have the following structure.

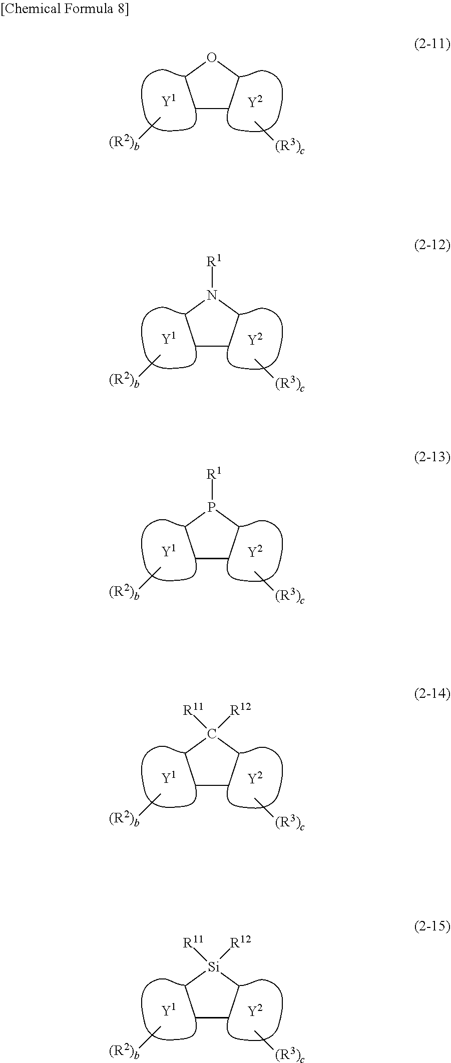

In general formulas (2-11) to (2-15), Y¹ and Y² are each a benzene ring or a naphthalene ring, and Y¹ and Y² are not both benzene rings at the same time. In a case where Y¹ or Y² is a benzene ring, b or c corresponding to the benzene ring Y¹ or Y² is 4. In a case where Y¹ and/or Y² is a naphthalene ring, b and/or c corresponding to the naphthalene ring Y¹ and/or Y² is 6.

R¹, R², R³, R¹¹, and R¹² are each a hydrogen atom or a substituent represented by *—Z¹(R⁴)_{d} (* represents a bond position). In a case where a plurality of R¹s, a plurality of R²s, and a plurality of R³s are present, the plurality of R¹s to R³s may be the same as or different from each other. However, R¹s, R²s, R³s, R¹¹, and R¹² in general formulas (2-11) to (2-15) are not all hydrogen atoms at the same time.

Z¹ represents a single bond, a divalent or higher valent saturated hydrocarbon group, or a divalent or higher valent unsaturated hydrocarbon group, and the saturated hydrocarbon group or the unsaturated hydrocarbon group may contain an ether bond and/or a thioether bond. In a case where Z¹ is a single bond, d is 1. In a case where Z¹ is a saturated hydrocarbon group or an unsaturated hydrocarbon group, d is an integer equal to or larger than 1.

R⁴ represents a hydrogen atom or a polymerizable substituent. In a case where a plurality of R⁴s is present, the plurality of R⁴s may be the same as or different from each other. However, R⁴s in general formulas (2-11) to (2-15) are not all hydrogen atoms at the same time.

Furthermore, in the above general formula (1-10), Y¹ and Y² are each a benzene ring or a naphthalene ring, and Y¹ and Y² are not both benzene rings at the same time.

Molecular refraction values of phenyl (C₆H₅) and naphthyl (C₁₀H₇) are phenyl (C₆H₅): 25.5 and naphthyl (C₁₀H₇): 43.3. (Optics, Vol. 44, No. 8, 2015, p 298-303). In the present embodiment, Y¹ and Y² are each preferably a naphthalene ring having a high molecular refraction value from a viewpoint of obtaining a compound having a high refractive index.

That is, the compound represented by general formula (1-10) may have the following structure.

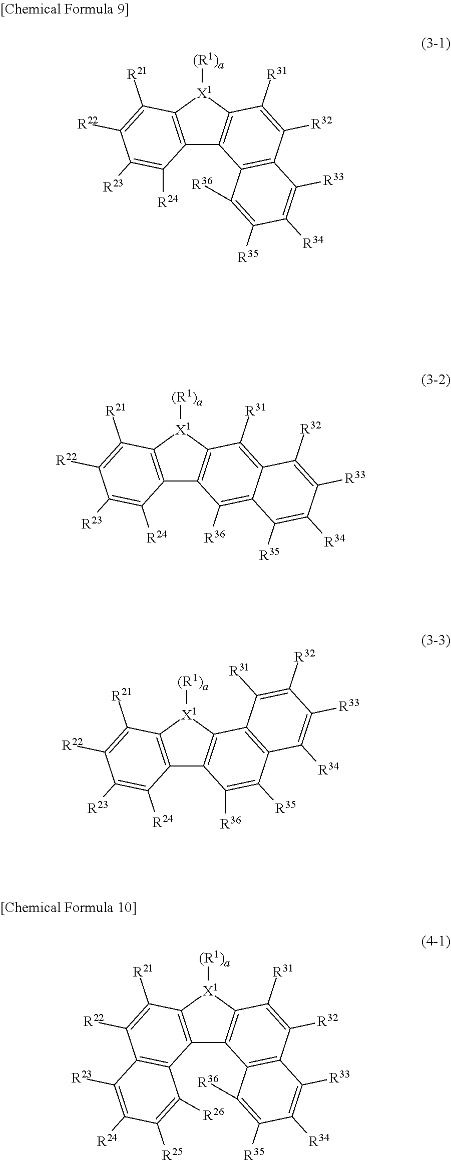

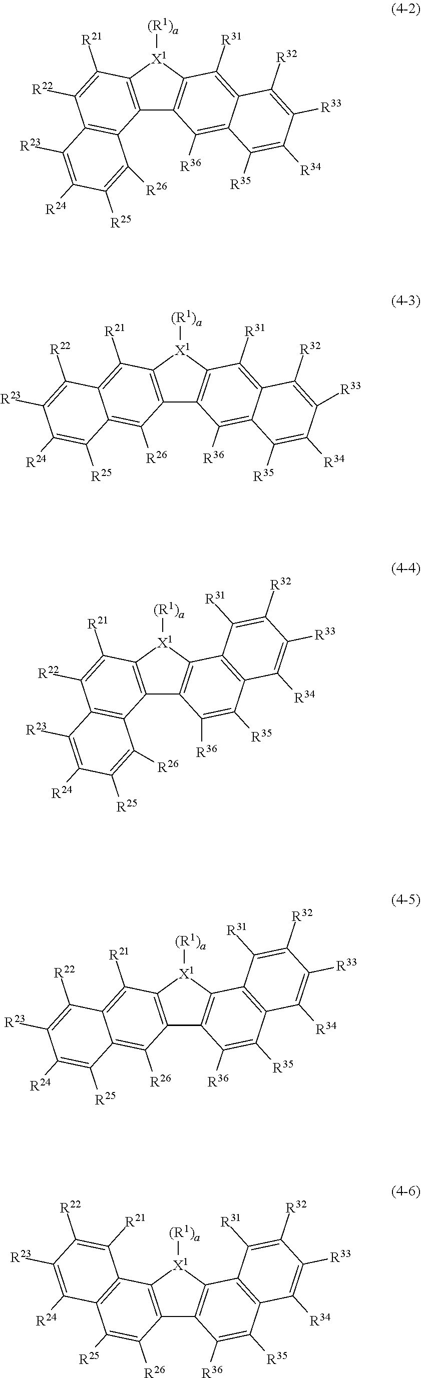

In general formulas (3-1) to (3-3) and (4-1) to (4-6), X¹ is an oxygen atom, a nitrogen atom, a phosphorus atom, a carbon atom, or a silicon atom. In a case where X¹ is an oxygen atom, a is 0. In a case where X¹ is a nitrogen atom or a phosphorus atom, a is 1. In a case where X¹ is a carbon atom or a silicon atom, a is 2.

R¹, R²¹ to R²⁶, and R³¹ to R³⁶ are each a hydrogen atom or a substituent represented by *—Z¹(R⁴)_{d} (* represents a bond position). R¹, R²¹ to R²⁶, and R³¹ to R³⁶ may be the same as or different from each other. Furthermore, in a case where a plurality of R¹s is present, the plurality of R¹s may be the same as or different from each other. However, R¹, R²¹ to R²⁶, and R³¹ to R³⁶ in general formulas (3-1) to (3-3) and (4-1) to (4-6) are not all hydrogen atoms at the same time.

Z¹ represents a single bond, a divalent or higher valent saturated hydrocarbon group, or a divalent or higher valent unsaturated hydrocarbon group, and the saturated hydrocarbon group or the unsaturated hydrocarbon group may contain an ether bond and/or a thioether bond. In a case where Z¹ is a single bond, d is 1. In a case where Z¹ is a saturated hydrocarbon group or an unsaturated hydrocarbon group, d is an integer equal to or larger than 1.

R⁴ represents a hydrogen atom or a polymerizable substituent. In a case where a plurality of R⁴s is present, the plurality of R⁴s may be the same as or different from each other. However, R⁴s in general formulas (3-1) to (3-3) and (4-1) to (4-6) are not all hydrogen atoms at the same time.

In the above general formula (1), Z¹ represents a single bond, a divalent or higher valent saturated hydrocarbon group, or a divalent or higher valent unsaturated hydrocarbon group. The saturated hydrocarbon group or the unsaturated hydrocarbon group may contain an ether bond and/or a thioether bond.

In a case where Z¹ is a divalent or higher valent saturated hydrocarbon group, the saturated hydrocarbon group may be a linear, branched, or cyclic substituted or unsubstituted hydrocarbon group. In general, an organic compound tends to have higher solubility as the number of simple carbon chains is longer, while the organic compound tends to have a lower refractive index as the number of simple carbon chains is longer. Therefore, the simple carbon chain number of the saturated hydrocarbon group is preferably 1 to 15, and more preferably 1 to 10.

Furthermore, in a case where Z¹ is a divalent or higher valent unsaturated hydrocarbon group, the unsaturated hydrocarbon group may be a linear, branched, or cyclic substituted or unsubstituted hydrocarbon group or aromatic group. The simple carbon chain number of the unsaturated hydrocarbon group is preferably 1 to 15, and more preferably 1 to 10. In a case where the unsaturated hydrocarbon group contains an aromatic group, the aromatic group is preferably a substituted or unsubstituted divalent or higher valent aromatic group represented by any one of the following chemical formulas (5-1) to (5-8). When four or more benzene rings are linearly connected to each other, the benzene rings have absorption in a visible light region and have a color, which is not preferable from a viewpoint of transparency in some cases. Therefore, the aromatic group preferably has a structure in which four or more benzene rings are not linearly arranged, and the linear shape is preferably up to a benzene ring, a naphthalene ring, or an anthracene ring.

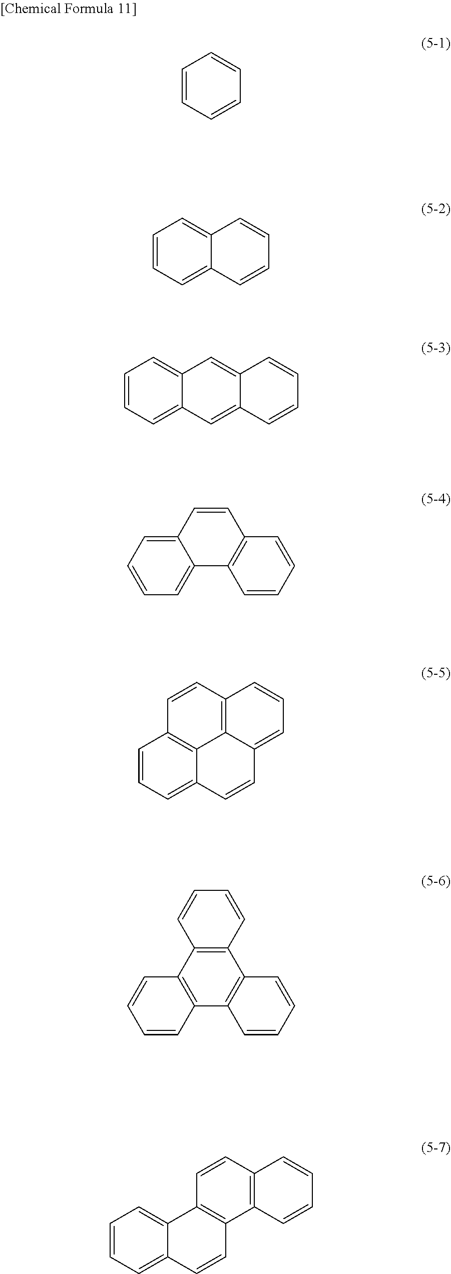

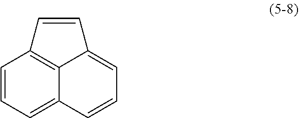 [SMILES: C1=Cc2cccc3cccc1c23]

In the above general formula (1-10), examples of the polymerizable substituent represented by R⁴ include a substituent having a polymerizable unsaturated group and a substituent having a reactive substituent. Examples of the substituent having a polymerizable unsaturated group include a vinyl group, an acrylic group, a methacrylic group, an acrylamide group, a methacrylamide group, a cyanoacrylate group, a cyanomethacrylate group, a vinyl ether group, a vinyl cyanide group, a vinyl nitrate group, a conjugate polyene group, a vinyl halide group, a vinyl ketone group, and a styryl group. Examples of the substituent having a reactive substituent include an epoxy group, an oxetane group, a hydroxy group, an amino group, a carboxyl group, an acid anhydride group, an acid halide group, and an isocyanate group.

In the above general formula (1-10), X¹ is preferably a nitrogen atom, and Y¹ and Y² are each preferably a naphthalene ring. That is, the compound is preferably a compound represented by the following general formula (1-1).

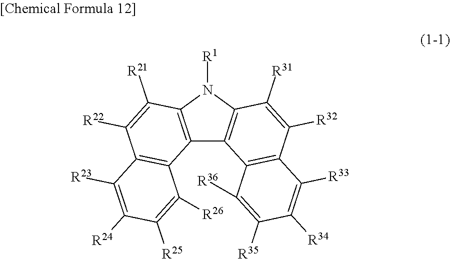

In general formula (1-1), R¹, R²¹ to R²⁶, and R³¹ to R³⁶ are each a hydrogen atom or a substituent represented by *—Z¹(R⁴)_{d} (* represents a bond position). R¹, R²¹ to R²⁶, and R³¹ to R³⁶ may be the same as or different from each other. However, R¹, R²¹ to R²⁶, and R³¹ to R³⁶ are not all hydrogen atoms at the same time.

Z¹ represents a single bond, a divalent or higher valent saturated hydrocarbon group, or a divalent or higher valent unsaturated hydrocarbon group, and the saturated hydrocarbon group or the unsaturated hydrocarbon group may contain an ether bond and/or a thioether bond. In a case where Z¹ is a single bond, d is 1. In a case where Z¹ is a saturated hydrocarbon group or an unsaturated hydrocarbon group, d is an integer equal to or larger than 1.

R⁴ represents a hydrogen atom or a polymerizable substituent. In a case where a plurality of R⁴s is present, the plurality of R⁴s may be the same as or different from each other. However, R⁴s in general formula (1-1) are not all hydrogen atoms at the same time.

In general formula (1-1), R¹ is preferably a substituent represented by *—Z¹(R⁴)_{d} (* represents a bond position), and R²¹ to R²⁶ and R³¹ to R³⁶ are each preferably a hydrogen atom.

Furthermore, in the above general formula (1-10), X¹ is preferably a carbon atom, and Y¹ and Y² are each preferably a naphthalene ring. That is, the compound is preferably a compound represented by the following general formula (1-2).

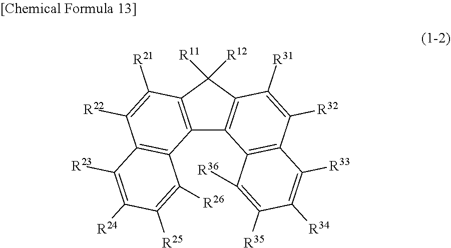

In general formula (1-2), R¹¹, R¹², R²¹ to R²⁶, and R³¹ to R³⁶ are each a hydrogen atom or a substituent represented by *—Z¹(R⁴)_{d} (* represents a bond position). R¹¹, R¹², R²¹ to R²⁶, and R³¹ to R³⁶ may be the same as or different from each other. However, R¹¹, R¹², R²¹ to R²⁶, and R³¹ to R³⁶ in general formula (1-2) are not all hydrogen atoms at the same time.

Z¹ represents a single bond, a divalent or higher valent saturated hydrocarbon group, or a divalent or higher valent unsaturated hydrocarbon group, and the saturated hydrocarbon group or the unsaturated hydrocarbon group may contain an ether bond and/or a thioether bond. In a case where Z¹ is a single bond, d is 1. In a case where Z¹ is a saturated hydrocarbon group or an unsaturated hydrocarbon group, d is an integer equal to or larger than 1.

R⁴ represents a hydrogen atom or a polymerizable substituent. In a case where a plurality of R⁴s is present, the plurality of R⁴s may be the same as or different from each other. However, R⁴s in general formula (1-2) are not all hydrogen atoms at the same time.

In general formula (1-2), R¹¹ and/or R¹² is preferably a substituent represented by *—Z¹(R⁴)_{d} (* represents a bond position), and R²¹ to R²⁶ and R³¹ to R³⁶ are each preferably a hydrogen atom.

The chemical structural formulas of preferable monofunctional exemplified compounds of the compound represented by general formula (1-10) are as follows.

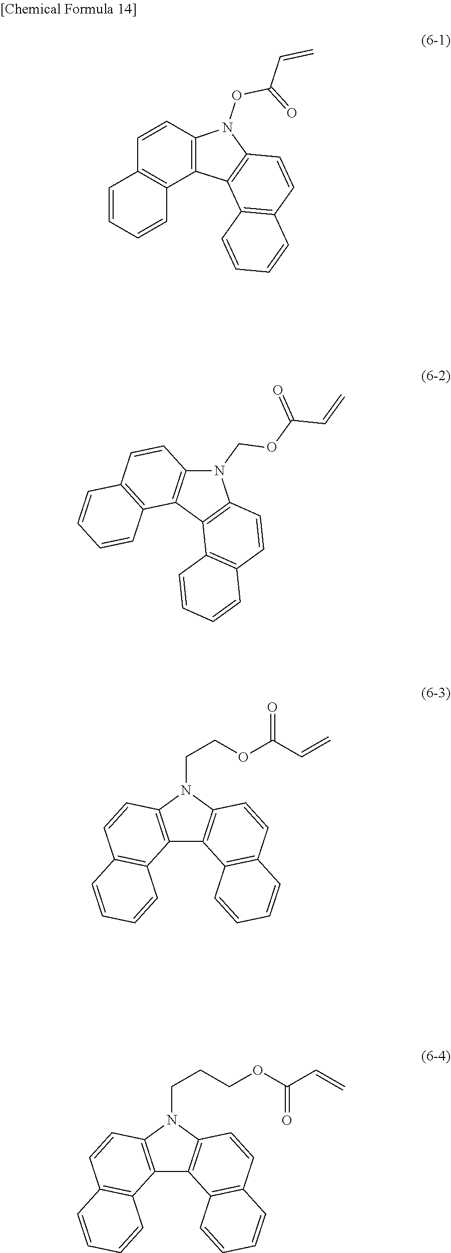

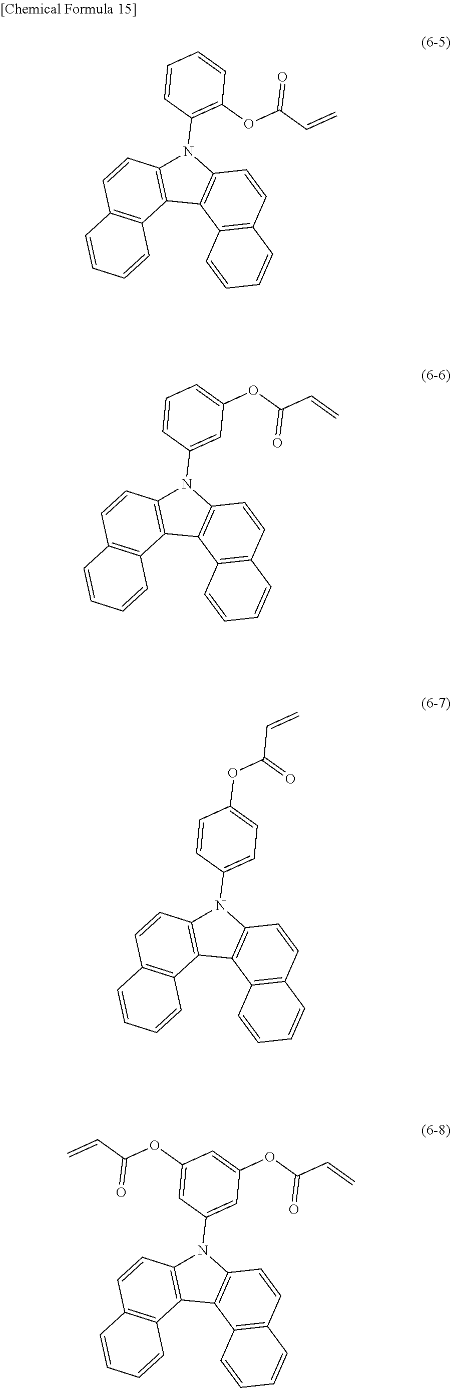

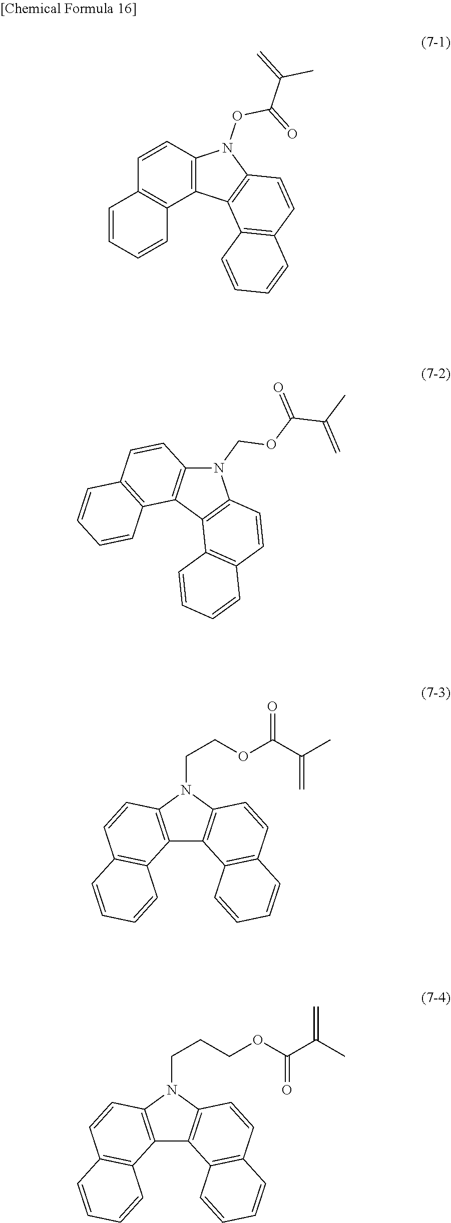

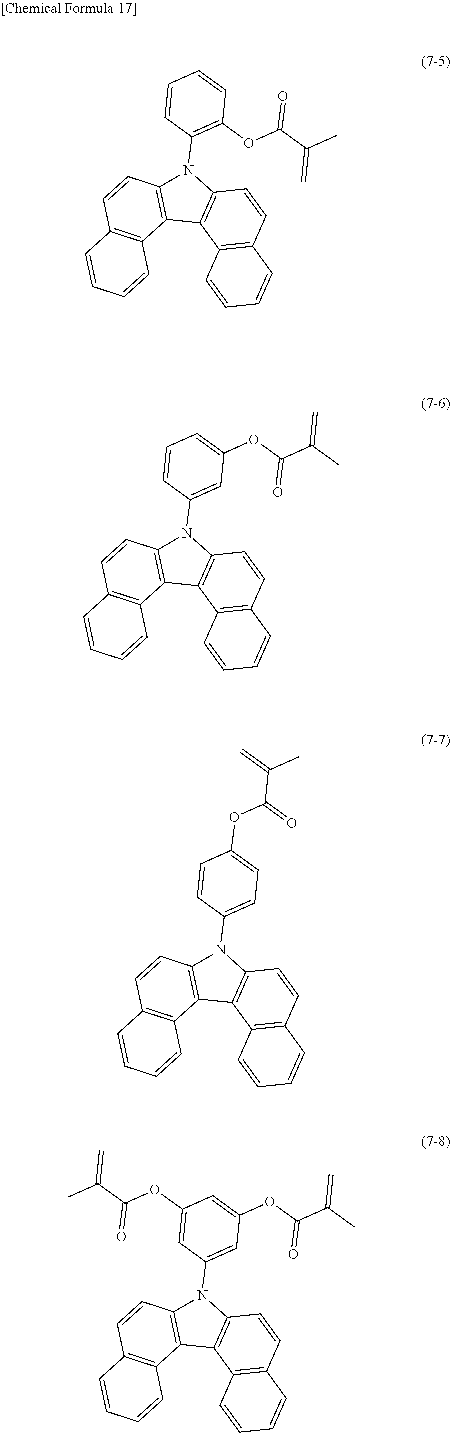

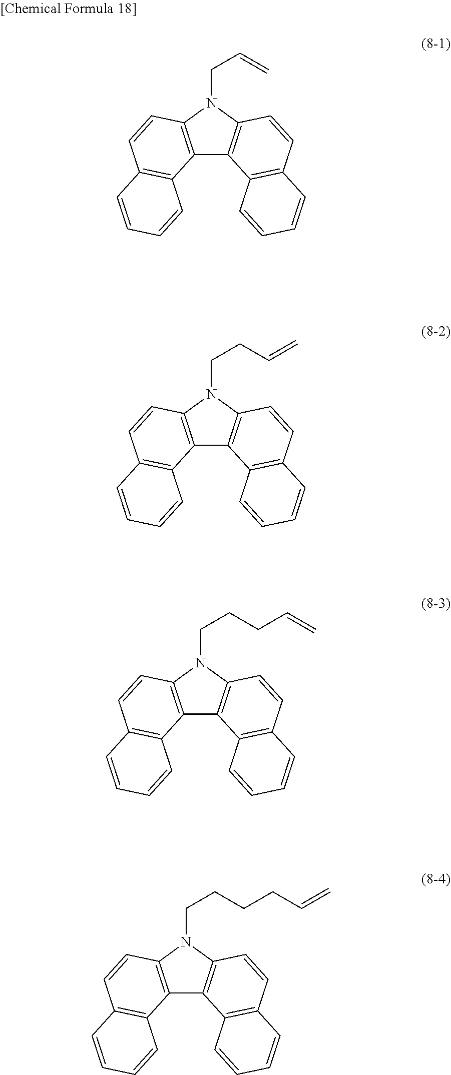

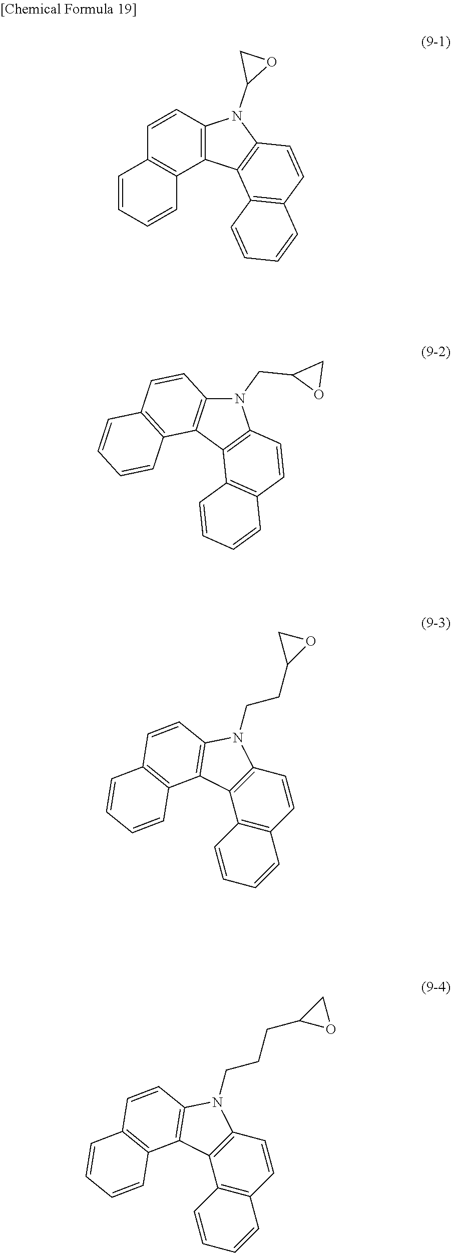

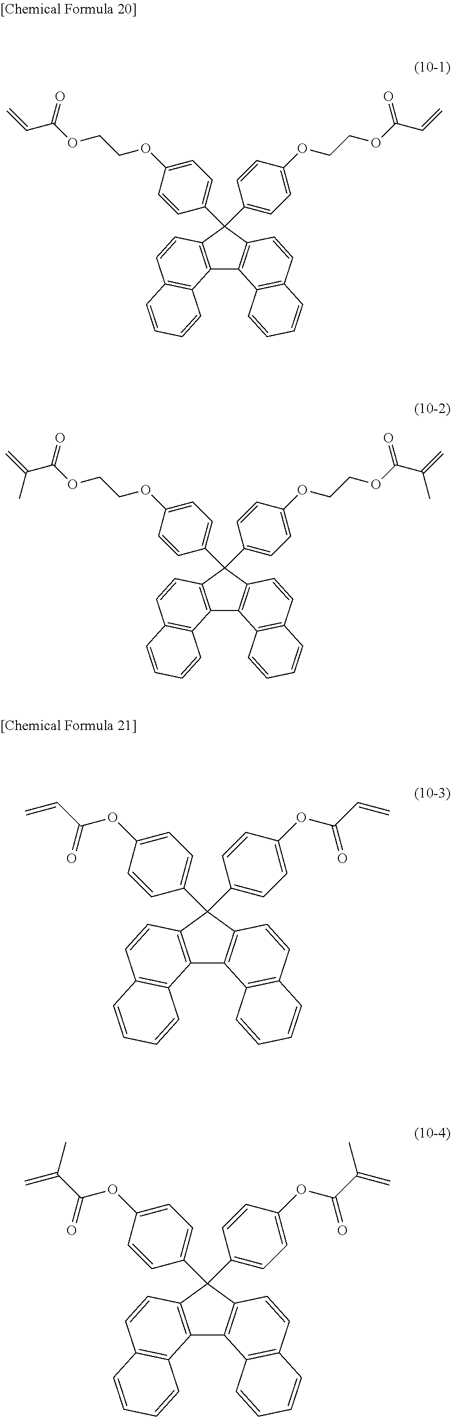

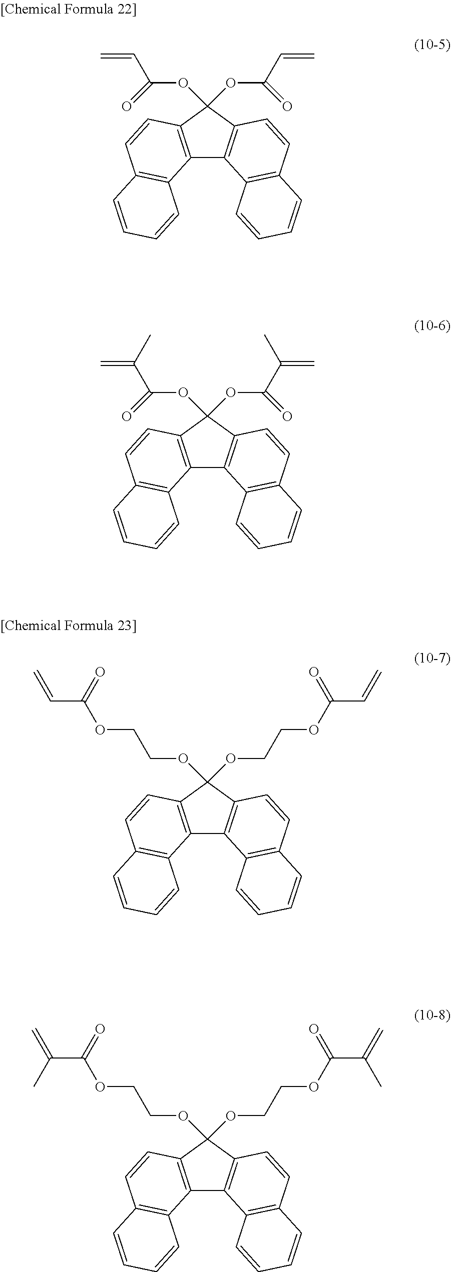

A lower limit of the refractive index of the compound represented by general formula (1-10) is preferably 1.60, more preferably 1.65, and still more preferably 1.70. On the other hand, an upper limit of the refractive index of the compound represented by general formula (1-10) is, for example, 1.80, but may be more than 1.80.

Note that the refractive index can be measured by a critical angle method or a spectroscopic ellipsometry method. For example, in the critical angle method, the refractive index can be measured using an Abbe refractive index meter ER-1 manufactured by Erma Inc. (measurement is performed using a measurement wavelength such as 486 nm, 589 nm, or 656 nm in a visible light region).

### [2-3. Matrix Resin]

The matrix resin contained in the hologram recording composition according to the present embodiment is not particularly limited, and any matrix resin can be used.

Examples of the matrix resin include a vinyl acetate-based resin such as polyvinyl acetate or a hydrolyzate thereof; an acrylic resin such as poly (meth)acrylate or a partial hydrolyzate thereof; polyvinyl alcohol or a partial acetal product thereof; triacetylcellulose; polyisoprene; polybutadiene; polychloroprene; silicone rubber; polystyrene; polyvinyl butyral; polyvinyl chloride; polyarylate; chlorinated polyethylene; chlorinated polypropylene; poly-N-vinylcarbazole or a derivative thereof; poly-N-vinylpyrrolidone or a derivative thereof; polyarylate; a copolymer of styrene and maleic anhydride or a semiester thereof; and a copolymer containing, as a polymerization component, at least one of copolymerizable monomers such as acrylic acid, acrylate, methacrylic acid, methacrylate, acrylamide, acrylnitrile, ethylene, propylene, vinyl chloride, and vinyl acetate, and one or more of these can be used. Moreover, as the copolymerization component, a monomer containing a thermosetting or photocurable functional group can also be used.

Furthermore, as the matrix resin, an oligomer type curable resin can also be used. Examples thereof include epoxy compounds generated by a condensation reaction between various phenol compounds such as bisphenol A, bisphenol S, novolak, o-cresol novolak, and p-alkylphenol novolak, and epichlorohydrin, and one or more of these can be used.

### [2-4. Photopolymerization Initiator]

The photopolymerization initiator contained in the hologram recording composition according to the present embodiment is not particularly limited, and any photopolymerization initiator can be used.

Examples of the photopolymerization initiator in the present embodiment include a radical polymerization initiator (radical generator), a cationic polymerization initiator (acid generator), and an agent having both of these functions. Note that as the photopolymerization initiator, an anionic polymerization initiator (base generator) may be used.

Examples of the radical polymerization initiator (radical generator) include an imidazole derivative, a bisimidazole derivative, an N-arylglycine derivative, an organic azide compound, a titanocene, an aluminate complex, an organic peroxide, an N-alkoxypyridinium salt, and a thioxanthone derivative.

Specific examples thereof include 1,3-di(t-butyldioxycarbonyl) benzophenone, 3,3′,4,4′-tetrakis(t-butyldioxycarbonyl) benzophenone, 3-phenyl-5-isoxazolone, 2-mercaptobenzimidazole, bis(2,4,5-triphenyl) imidazole, 2,2-dimethoxy-1,2-diphenylethan-1-one (trade name: Irgacure 651 manufactured by Ciba Specialty Chemicals Co., Ltd.), 1-hydroxy-cyclohexyl-phenyl-ketone (trade name: Irgacure 184, manufactured by Ciba Specialty Chemicals Co., Ltd.), 2-benzyl-2-dimethylamino-1-(4-morpholinophenyl)-butanone-1 (trade name: Irgacure 369, manufactured by Ciba Specialty Chemicals Co., Ltd.), and bis(η5-2,4-cyclopentadien-1-yl)-bis(2,6-difluoro-3-(1H-pyrrol-1-yl)-phenyl) titanium (trade name: Irgacure 784 manufactured by Ciba Specialty Chemicals Co., Ltd.), but are not limited thereto.

Examples of the cationic polymerization initiator (acid generator) include sulfonate, imide sulfonate, a dialkyl-4-hydroxysulfonium salt, an aryl sulfonic acid-p-nitrobenzyl ester, a silanol-aluminum complex, and (η6-benzene) (η5-cyclopentadienyl) iron (II).

Specific examples thereof include benzointosylate, 2,5-dinitrobenzyltosylate, and N-imide tosyphthalate, but are not limited thereto.

Examples of the agent used as both a radical polymerization initiator (radical generator) and a cationic polymerization initiator (acid generator) include a diaryliodonium salt, a diaryliodonium organic boron complex, an aromatic sulfonium salt, an aromatic diazonium salt, an aromatic phosphonium salt, a triazine compound, and an iron arene complex-based compound.

Specific examples thereof include: an iodonium salt such as a chloride, a bromide, a borofluoride salt, a hexafluorophosphate salt, or a hexafluoroantimonate salt of an iodonium such as 4-isopropyl-4′-methyldiphenyliodonium tetrakis(pentafluorophenyl) borate, diphenyliodonium, ditolyliodonium, bis(p-tert-butylphenyl) iodonium, or bis(p-chlorophenyl) iodonium; a sulfonium salt such as a chloride, a bromide, a borofluoride salt, a hexafluorophosphate salt, or a hexafluoroantimonate salt of a sulfonium such as triphenylsulfonium, 4-tert-butyltriphenylsulfonium, or tris(4-methylphenyl) sulfonium; and a 2,4,6-substituted-1,3,5-triazine compound such as 2,4,6-tris(trichloromethyl)-1,3,5-triazine, 2-phenyl-4,6-bis(trichloromethyl)-1,3,5-triazine, or 2-methyl-4,6-bis(trichloromethyl)-1,3,5-triazine, but are not limited thereto.

### [2-5. Anthracene-Based Compound]

The anthracene-based compound contained in the hologram recording composition according to the present embodiment has an effect of controlling a reaction rate of a polymerization reaction occurring in a bright part during interference exposure. Since the reaction rate control works advantageously for formation of a separated structure of a hologram, diffraction characteristics of an obtained hologram can be made favorable. Furthermore, the anthracene-based compound has a specific absorption region derived from an anthracene skeleton on a long wavelength side (around 350 nm to 400 nm) as illustrated in FIG. 1, therefore has high UV absorption efficiency, can improve UV energy utilization efficiency in a UV irradiation step, can suppress UV irradiation on a substance that is yellowed by UV, and therefore can suppress yellowing of a hologram to make transparency favorable.

The anthracene compound in the present embodiment is preferably a compound represented by the following general formula (5).

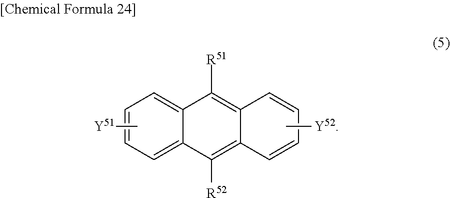

In the above formula (5), examples of R⁵¹ and R⁵² include a hydrocarbon group such as an alkyl group (a C₁₋₁₂ alkyl group such as a methyl group, an ethyl group, a propyl group, an isopropyl group, or a butyl group), a cycloalkyl group (a cyclohexyl group and the like), an aryl group (a phenyl group, a tolyl group, a xylyl group, a naphthyl group, and the like), or an aralkyl group (a benzyl group, a phenethyl group, and the like); a group-OR⁵³ [in which R⁵³ represents a hydrogen atom or a hydrocarbon group (the above-exemplified hydrocarbon groups and the like)] such as an alkoxy group (a C₁₋₁₂ alkoxy group such as a methoxy group or an ethoxy group, and the like), a hydroxyalkyl group (a hydroxymethyl group, a hydroxyethyl group, and the like), a cycloalkoxy group (a cyclohexyloxy group and the like), an aryloxy group (a phenoxy group and the like), or an aralkyloxy group (a benzyloxy group and the like); a group-SR³⁵ (in which R⁵³ is the same as above) such as an alkylthio group (a methylthio group, an ethylthio group, and the like), a cycloalkylthio group (a cyclohexylthio group and the like), an arylthio group (a thiophenoxy group and the like), or an aralkylthio group (a benzylthio group and the like); an acyl group (an acetyl group and the like); an alkoxycarbonyl group (a methoxycarbonyl group and the like); a hydrogen atom; a halogen atom (a fluorine atom, a chlorine atom, a bromine atom, an iodine atom, and the like); a nitro group; a cyano group; and a substituted amino group (a dialkylamino group such as a dimethylamino group, and the like). Note that R⁵¹ and R⁵² in formula (5) may be different from or the same as each other.

In the above formula (5), examples of Y⁵¹ and Y⁵² include a hydrocarbon group such as an alkyl group (a C₁₋₁₂ alkyl group such as a methyl group, an ethyl group, a propyl group, an isopropyl group, a butyl group, or a t-butyl group, and the like), or an aryl group (a C₆₋₁₀ aryl group such as phenyl group); a hydrogen atom; and a halogen atom (a fluorine atom, a chlorine atom, a bromine atom, and the like). Note that Y⁵¹ and Y⁵² in formula (5) may be different from or the same as each other.

The anthracene compound represented by the above general formula (5) can be synthesized by various known synthetic methods, but for example, can be synthesized on the basis of the synthetic method described in Japanese Patent Application Laid-Open No. 2018-018061.

In the present embodiment, among the anthracene-based compounds represented by general formula (5), for example, 9,10-dibutoxyanthracene (“UVS-1331” manufactured by Kawasaki Kasei Chemicals Ltd.), 9,10-diethoxyanthracene (“UVS-1101” manufactured by Kawasaki Kasei Chemicals Ltd.), 2-tert-butyl anthracene (manufactured by Tokyo Kasei Kogyo Co., Ltd.), 9-(hydroxyethyl) anthracene (manufactured by Tokyo Kasei Kogyo Co., Ltd.), and N-phenyl-9-anthramine (manufactured by Tokyo Chemical Industry Co., Ltd.) are preferably used.

The content of the anthracene-based compound in the hologram recording composition may be appropriately set by those skilled in the art, but is preferably 0.08 to 10% by mass, and more preferably 0.08 to 7% by mass with respect to the total mass of the hologram recording composition from a viewpoint of making UV absorption by the anthracene-based compound favorable. In a case where the content of the anthracene-based compound is less than 0.08% by mass, UV absorption by the anthracene-based compound may be insufficient. On the other hand, in a case where the content of the anthracene-based compound exceeds 10% by mass, crystallization may occur depending on the type of anthracene-based compound.

### [2-6. Inorganic Fine Particles]

The hologram recording composition according to the present embodiment may contain inorganic fine particles. By using the inorganic fine particles, the refractive index modulation amount (Δn) can be increased. The inorganic fine particles are not particularly limited, but are preferably TiO₂ fine particles or ZrO₂ fine particles.

The hologram recording composition according to the present embodiment may contain one type of inorganic fine particles, or may contain two or more types of inorganic fine particles. For example, the above-described TiO₂ fine particles and ZrO₂ fine particles may be used in combination.

In a preferable aspect, the hologram recording composition according to the present embodiment contains at least the above-described monofunctional and polyfunctional acrylates or methacrylates and TiO₂ fine particles.

In a preferable aspect, the hologram recording composition according to the present embodiment contains at least the above-described monofunctional and polyfunctional acrylates or methacrylates and ZrO₂ fine particles.

The content of the inorganic fine particles in the hologram recording composition may be appropriately set by those skilled in the art, but is preferably 15 to 85% by mass with respect to the total mass of the hologram recording composition.

### [2-7. Plasticizer]

The hologram recording composition according to the present embodiment may contain a plasticizer. The plasticizer is effective for preparing the adhesiveness, flexibility, hardness, and other physical characteristics of the hologram recording composition.

Examples of the plasticizer include triethylene glycol, triethylene glycol diacetate, triethylene glycol dipropionate, triethylene glycol dicaprylate, triethylene glycol dimethyl ether, poly(ethylene glycol), poly(ethylene glycol) methyl ether. triethylene glycol bis(2-ethylhexanoate), tetraethylene glycol diheptanoate, diethyl sepacate, dibutyl suberate, tris(2-ethylhexyl) phosphate, isozolovyl naphthalene, diisopropyl naphthalene, poly(propylene glycol), glyceryl tributyrate, diethyl adipate, diethyl sebacate, nobutyl superate, tributyl phosphate, and tris(2-ethylhexyl) phosphate. One or more of these can be used.

Furthermore, as the plasticizer, a cationically polymerizable compound can be used. Examples of the cationically polymerizable compound include an epoxy compound and an oxetane compound. The plasticizer in the present embodiment is preferably a cationically polymerizable compound from a viewpoint of being cured after exposure and being able to make retention of diffraction characteristics of an obtained hologram favorable. Above all, one or more selected from an epoxy compound and an oxetane compound are more preferably used.

As the epoxy compound, for example, glycidyl ether and the like can be used. Specific examples of the glycidyl ether include allyl glycidyl ether, phenyl glycidyl ether, 1,4-butanediol diglycidyl ether, 1,5-pentanediol diglycidyl ether, 1,6-hexanediol diglycidyl ether, 1,8-octanediol diglycidyl ether, 1,10-decanediol diglycidyl ether, 1,12-dodecanediol diglycidyl ether, ethylene glycol diglycidyl ether, diethylene glycol diglycidyl ether, polyethylene glycol diglycidyl ether, polypropylene glycol diglycidyl ether, neopentyl glycol diglycidyl ether, bisphenol A diglycidyl ether, bisphenol F diglycidyl ether, trimethylolpropane diglycidyl ether, glycerin triglycidyl ether, diglycerol triglycidyl ether, sorbitol polyglycidyl ether, and pentaerythritol polyglycidyl ether. One or more of these can be used.

Examples of the oxetane compound include 3-ethyl-3-hydroxymethyloxetane, 2-ethylhexyloxetane, xylylene bisoxetane, 3-ethyl-3{[(3-ethyloxetan-3-yl) methoxy] methyl} oxetane, 2-hydroxyethyl vinyl ether, 4-hydroxybutyl vinyl ether, diethylene glycol monovinyl ether, and 2-ethylhexyl vinyl ether. One or more of these can be used.

The content of the plasticizer in the hologram recording composition may be appropriately set by those skilled in the art, but is preferably 5 to 40% by mass with respect to the total mass of the hologram recording composition.

### [2-8. Polymerization Inhibitor]

The hologram recording composition according to the present embodiment may contain a polymerization inhibitor. The polymerization inhibitor is not particularly limited, but examples thereof include a quinone-based compound such as hydroquinone; a hindered phenol-based compound; a benzotriazole compound; and a thiazine-based compound such as phenothiazine. One or more of these may be used.

The content of the polymerization inhibitor in the hologram recording composition may be appropriately set by those skilled in the art, but is preferably 0.01 to 1.0% by mass, and more preferably 0.05 to 0.5% by mass with respect to the total mass of the hologram recording composition.

### [2-9. Other Components]

The hologram recording composition according to the present embodiment may contain a sensitizing dye, a chain transfer agent, a solvent, and the like in addition to the above-described components.

The sensitizing dye can sensitize the sensitivity of the photopolymerization initiator to light. Specific examples thereof include a thiopyrylium salt-based dye, a merocyanine-based dye, a quinoline-based dye, a rose bengal-based dye, a styrylquinolin-based dye, a ketocoumarin-based dye, a thioxanthene-based dye, a xanthene-based dye, an oxonol-based dye, a cyanine-based dye, a rhodamine-based dye, a pyrylium salt-based dye, a cyclopentanone-based dye, and a cyclohexanone-based dye. Specific examples of the cyanine-based and merocyanine-based dyes include 3,3′-dicarboxyethyl-2,2′-thiocyanine bromide, 1-carboxymethyl-1′-carboxyethyl-2,2′-quinocyanine bromide, 1,3′-diethyl-2,2′-quinothiacyanine iodide, and 3-ethyl-5-[(3-ethyl-2 (3H)-benzothiazolilidene) ethylidene]-2-thioxo-4-oxazolidine. Specific examples of the coumarin-based and ketocoumarin-based dyes include 3-(2′-benzimidazole)-7-diethylaminocoumarin, 3,3′-carbonylbis(7-diethylaminocoumarin), 3,3′-carbonylbiscoumarin, 3,3′-carbonylbis(5,7-dimethoxycoumarin), and 3,3′-carbonylbis(7-acetoxycoumarin). One or more of these can be used.

The chain transfer agent can abstract a radical from a growth end in a polymerization reaction to stop growth and becomes a new polymerization reaction initiator species, which is added to the radically polymerizable monomer to be able to start growth of a new polymer. Use of the chain transfer agent increases the frequency of chain transfer of radical polymerization. As a result, the reaction rate of the radically polymerizable monomer is increased, and the sensitivity to light can be improved. Furthermore, the reaction rate of the radically polymerizable monomer is increased, and reaction contributing components are increased. Therefore, the degree of polymerization of the radically polymerizable monomer can be adjusted.

Examples of the chain transfer agent include α-methylstyrene dimer, 2-mercaptobenzoxazole, 2-mercaptobenzothiazole, tert-butyl alcohol, n-butanol, isobutanol, isopropylbenzene, ethylbenzene, chloroform, methylethylketone, propylene, and vinyl chloride. One or more of these can be used.

The solvent can be effective for adjusting viscosity and compatibility, improving a film-forming property, and the like.

Examples of the solvent include acetone, xylene, toluene, methyl ethyl ketone, tetrahydrofuran, benzene, methylene chloride, dichloromethane, chloroform, and methanol. One or more of these can be used.

### [2-10. Method for Manufacturing Hologram Recording Composition]

The hologram recording composition according to the first embodiment of the present technology can be manufactured, for example, by adding a radically polymerizable monomer, a matrix resin, a photopolymerization initiator, and an anthracene-based compound in predetermined amounts to the above-described solvent at room temperature or the like, and dissolving and mixing the radically polymerizable monomer, the matrix resin, the photopolymerization initiator, and the anthracene-based compound. Furthermore, the above-described inorganic fine particles, plasticizer, polymerization inhibitor, sensitizing dye, chain transfer agent, and the like may be added depending on an intended use, a purpose, and the like. In a case where the hologram recording composition according to the first embodiment of the present technology is used for a hologram recording medium described later, the hologram recording composition may be used as a coating liquid.

### 3. Second Embodiment (Hologram Recording Medium)

### [3-1. Hologram Recording Medium]

A hologram recording medium according to a second embodiment of the present technology is a hologram recording medium including a photocurable resin layer containing at least a radically polymerizable monomer, a matrix resin, a photopolymerization initiator, and an anthracene-based compound. The hologram recording medium according to the present embodiment contains the hologram recording composition according to the first embodiment of the present technology.

The hologram recording medium according to the present embodiment may contain the photocurable resin layer and at least one transparent base material, and the photocurable resin layer may be formed on the at least one transparent base material.

Here, FIG. 2 illustrates a schematic cross-sectional view of an example of the hologram recording medium according to the present embodiment. A hologram recording medium 1 illustrated has a three-layer structure in which a photocurable resin layer 12 is disposed between a transparent protective film 11 (transparent base material) and a glass or film substrate (transparent base material) 13. As described above, the hologram recording medium according to the present embodiment may have a three-layer structure in which a photocurable resin layer is formed on a first transparent base material, and moreover a second transparent base material is formed on a main surface of the photocurable resin layer on which the first transparent base material is not formed.

The hologram recording medium according to the second embodiment of the present technology can provide a hologram having a high refractive index modulation amount (An) without going through a heating step after exposure. Furthermore, the hologram recording medium can make the transparency of the hologram favorable.

### [3-2. Photocurable Resin Layer]

The photocurable resin layer included in the hologram recording medium according to the second embodiment of the present technology contains at least a radically polymerizable monomer, a matrix resin, a photopolymerization initiator, and an anthracene-based compound. The photocurable resin layer contains materials of the hologram recording composition according to the first embodiment of the present technology, and all the contents described for each of the materials in the above section 2 also apply to the photocurable resin layer of the hologram recording medium in the present embodiment. The photocurable resin layer of the hologram recording medium may be constituted by the hologram recording composition according to the first embodiment of the present technology and other materials, or may be constituted by the hologram recording composition according to the first embodiment of the present technology.

The thickness of the photocurable resin layer of the hologram recording medium according to the present embodiment may be appropriately set by those skilled in the art, but is preferably 0.1 to 100 μm, and more preferably 1 to 30 μm from a viewpoint of diffraction efficiency and sensitivity to light.

### [3-3. Transparent Base Material]

The hologram recording medium according to the second embodiment of the present technology may contain at least one transparent base material. As the transparent base material, a glass substrate, a transparent resin substrate, and the like may be used.

Specific examples of the transparent resin substrate include a polyester film such as a polyethylene film, a polypropylene film, a polyethylene fluoride-based film, a polyvinylidene fluoride film, a polyvinyl chloride film, a polyvinylidene chloride film, an ethylene-vinyl alcohol film, a polyvinyl alcohol film, a polymethyl methacrylate film, a polyether sulfone film, a polyether ether ketone film, a polyamide film, a tetrafluoroethylene-perfluoroalkyl vinyl copolymer film, or a polyethylene terephthalate film; and a polyimide film.

The thickness of the transparent base material of the hologram recording medium according to the present embodiment may be appropriately set by those skilled in the art, but is preferably 0.1 to 100 μm, and more preferably 1 to 30 μm from a viewpoint of transparency and rigidity of the hologram recording medium. The film exemplified above can be used as a protective film of the hologram recording medium, and the film can be laminated on a coated surface. In this case, a contact surface between the laminate film and the coated surface may be subjected to a mold release treatment such that the film can be easily peeled off later.

### [3-4. Method for Manufacturing Hologram Recording Medium]

The hologram recording medium according to the second embodiment of the present technology can be obtained, for example, by applying a coating liquid constituted by the hologram recording composition described in the above section 2 onto a transparent base material using a spin coater, a gravure coater, a comma coater, a bar coater, and the like, and then drying the coating liquid to form a photocurable resin layer.

### 4. Third Embodiment (Hologram)

### [4-1. Hologram]

A hologram according to a third embodiment of the present technology can be obtained by using the hologram recording medium according to the second embodiment of the present technology. The hologram according to the present embodiment can be obtained, for example, by exposing the hologram recording medium to light by a method described later. The hologram contains at least, for example, a polymer and/or an oligomer containing a structural unit derived from a radically polymerizable monomer and a matrix resin, a product obtained by a structural change of a photopolymerization initiator by generation of an active species due to irradiation with external energy, and a decolorized product of a sensitizing dye compound. Note that the hologram contains a hologram film and a holographic optical element.

The hologram according to the third embodiment of the present technology has a high refractive index modulation amount (Δn) without going through a heating step after exposure. Furthermore, the hologram has favorable transparency.

The hologram according to the present embodiment contains an anthracene-based compound, and therefore has a specific absorption region derived from an anthracene skeleton as illustrated in FIG. 1 on a long wavelength side (around 350 nm to 400 nm).

### [4-2. Method for Manufacturing Hologram]

The hologram according to the third embodiment of the present technology can be obtained, for example, by exposing the hologram recording medium according to the second embodiment of the present technology to two light fluxes using a semiconductor laser in a visible light region, then irradiating the entire surface with (ultraviolet rays) UV to cure an uncured monomer and the like, and fixing a refractive index distribution to the hologram recording medium. Conditions for the exposure with two light fluxes may be appropriately set by those skilled in the art according to an intended use, a purpose, and the like of the hologram. However, it is desirable to perform exposure preferably for 1 to 1000 seconds by setting the light intensity of one light flux on the hologram recording medium to 0.1 to 100 mW/cm², and to perform interference exposure such that an angle between the two light fluxes is 0.1 to 179.9 degrees.

### 5. Fourth Embodiment (Optical Device and Optical Component)

An optical device and an optical component according to a fourth embodiment of the present technology use the hologram according to the third embodiment of the present technology.

Examples of the optical device and the optical component include an image display device such as an eyewear, a holographic screen, a transparent display, a head mount display, or a head-up display, an imaging device, an imaging element, a color filter, a diffractive lens, a light guide plate, a spectroscopic element, a hologram sheet, an information recording medium such as an optical disk or a magneto-optical disk, an optical pickup device, a polarizing microscope, and a sensor.

The optical device and the optical component according to the fourth embodiment of the present technology each use a hologram having excellent diffraction characteristics. Therefore, it is possible to achieve an optical device and an optical component each having high optical characteristics and optical stability. Moreover, the optical device and the optical component according to the present embodiment each have favorable transparency. Therefore, for example, in a case where the present technology is used for a display, a display having a high see-through property can be obtained.

Note that the embodiments of the present technology are not limited to the above-described embodiments, and various modifications can be made thereto without departing from the gist of the present technology.

Furthermore, the effects described here are merely examples, and the effects of the present technology are not limited thereto, and may include other effects.

Note that the present technology may have the following configurations.

[1]

A hologram recording composition containing at least a radically polymerizable monomer, a matrix resin, a photopolymerization initiator, and an anthracene-based compound.

[2]

The hologram recording composition according to [1], containing a monofunctional monomer and a polyfunctional monomer as the radically polymerizable monomer.

[3]

The hologram recording composition according to [1] or [2], in which the radically polymerizable monomer has a refractive index of 1.6 or more.

[4]

The hologram recording composition according to any one of [1] to [3], in which the radically polymerizable monomer is at least one selected from the group consisting of a carbazole-based monomer, a fluorene-based monomer, and a dinaphthothiophene-based monomer.

[5]

The hologram recording composition according to any one of [1] to [3], in which the radically polymerizable monomer is a compound represented by the following general formula (1-10).

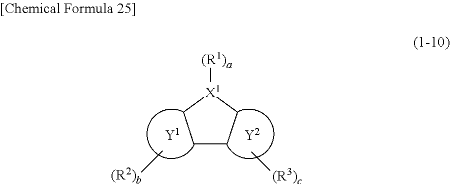

(In the general formula (1-10), X¹ is an oxygen atom, a nitrogen atom, a phosphorus atom, a carbon atom, or a silicon atom. In a case where X¹ is an oxygen atom, a is 0. In a case where X¹ is a nitrogen atom or a phosphorus atom, a is 1. In a case where X¹ is a carbon atom or a silicon atom, a is 2.

Y¹ and Y² are each a benzene ring or a naphthalene ring, and Y¹ and Y² are not both benzene rings at the same time. In a case where Y¹ or Y² is a benzene ring, b or c corresponding to the benzene ring Y¹ or Y² is 4. In a case where Y¹ and/or Y² is a naphthalene ring, b and/or c corresponding to the naphthalene ring Y¹ and/or Y² is 6.

R¹ to R³ are each a hydrogen atom or a substituent represented by *—Z¹(R⁴)_{d} (* represents a bond position). In a case where a plurality of R¹s, a plurality of R²s, and a plurality of R³s are present, the plurality of R¹s to R³s may be the same as or different from each other. However, R¹s to R³s in the general formula (1-10) are not all hydrogen atoms at the same time.

Z¹ represents a single bond, a divalent or higher valent saturated hydrocarbon group, or a divalent or higher valent unsaturated hydrocarbon group, and the saturated hydrocarbon group or the unsaturated hydrocarbon group may contain an ether bond and/or a thioether bond. In a case where Z¹ is a single bond, d is 1. In a case where Z¹ is a saturated hydrocarbon group or an unsaturated hydrocarbon group, d is an integer equal to or larger than 1.

R⁴ represents a hydrogen atom or a polymerizable substituent. In a case where a plurality of R⁴s is present, the plurality of R⁴s may be the same as or different from each other. However, R⁴s in the general formula (1-10) are not all hydrogen atoms at the same time.)

[6]

The hologram recording composition according to [1] or [2], further containing inorganic fine particles.

[7]

The hologram recording composition according to any one of [1] to [6], further containing a cationically polymerizable compound.

[8]

The hologram recording composition according to any one of [1] to [7], in which the cationically polymerizable compound is at least one selected from the group consisting of an epoxy compound and an oxetane compound.

[9]

The hologram recording composition according to [1] to [8], further containing a polymerization inhibitor.

[10]

A hologram recording medium including a photocurable resin layer containing at least a radically polymerizable monomer, a matrix resin, a photopolymerization initiator, and an anthracene-based compound.

[11]

The hologram recording medium according to [10], containing a monofunctional monomer and a polyfunctional monomer as the radically polymerizable monomer.

[12]

The hologram recording medium according to [10] or [11], in which the radically polymerizable monomer has a refractive index of 1.6 or more.

[13]

The hologram recording medium according to any one of [10] to [12], in which the radically polymerizable monomer is at least one selected from the group consisting of a carbazole-based monomer, a fluorene-based monomer, and a dinaphthothiophene-based monomer.

[14]

The hologram recording medium according to any one of [10] to [12], in which the radically polymerizable monomer is a compound represented by the following general formula (1-10).

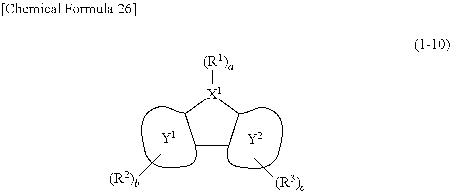

(In the general formula (1-10), X¹ is an oxygen atom, a nitrogen atom, a phosphorus atom, a carbon atom, or a silicon atom. In a case where X¹ is an oxygen atom, a is 0. In a case where X¹ is a nitrogen atom or a phosphorus atom, a is 1. In a case where X¹ is a carbon atom or a silicon atom, a is 2.

Y¹ and Y² are each a benzene ring or a naphthalene ring, and Y¹ and Y² are not both benzene rings at the same time. In a case where Y¹ or Y² is a benzene ring, b or c corresponding to the benzene ring Y¹ or Y² is 4. In a case where Y¹ and/or Y² is a naphthalene ring, b and/or c corresponding to the naphthalene ring Y¹ and/or Y² is 6.

R¹ to R³ are each a hydrogen atom or a substituent represented by *—Z¹(R⁴)_{d} (* represents a bond position). In a case where a plurality of R¹s, a plurality of R²s, and a plurality of R³s are present, the plurality of R¹s to R³s may be the same as or different from each other. However, R¹s to R³s in the general formula (1-10) are not all hydrogen atoms at the same time.

Z¹ represents a single bond, a divalent or higher valent saturated hydrocarbon group, or a divalent or higher valent unsaturated hydrocarbon group, and the saturated hydrocarbon group or the unsaturated hydrocarbon group may contain an ether bond and/or a thioether bond. In a case where Z¹ is a single bond, d is 1. In a case where Z¹ is a saturated hydrocarbon group or an unsaturated hydrocarbon group, d is an integer equal to or larger than 1.

R⁴ represents a hydrogen atom or a polymerizable substituent. In a case where a plurality of R⁴s is present, the plurality of R⁴s may be the same as or different from each other. However, R⁴s in the general formula (1-10) are not all hydrogen atoms at the same time.)

[15]

The hologram recording medium according to [10] or [11], further containing inorganic fine particles.

[16]

The hologram recording medium according to any one of [10] to [15], further containing a cationically polymerizable compound.

[17]

The hologram recording medium according to any one of [10] to [16], in which the cationically polymerizable compound is at least one selected from the group consisting of an epoxy compound and an oxetane compound.

[18]

The hologram recording medium according to any one of [10] to [17], further containing a polymerization inhibitor.

[19]

A hologram using the hologram recording medium according to any one of [10] to [18].

[20]

The hologram according to [19], having absorption derived from an anthracene skeleton.

[21]

An optical device using the hologram according to [19] or [20].

[22]

An optical component using the hologram according to [19] or [20].

### EXAMPLES

Hereinafter, the effects of the present technology will be specifically described with reference to Examples. Note that the scope of the present technology is not limited to the Examples.

### Example 1

### (Preparation of Hologram Recording Composition 1)

According to the amounts illustrated in Table 1 below, bisphenoxyethanol fluorene diacrylate (“EA-0200” manufactured by Osaka Gas Chemicals Co., Ltd., refractive index: 1.62) and 2-(9H-carbazol-9-yl) ethyl acrylate (“EACz” manufactured by SIGMA ALDRICH, refractive index: 1.65) as radically polymerizable monomers, polyvinyl acetate (“SN-55T” manufactured by Denka Company Limited) as a matrix resin, diethyl sebacate (“SDE” manufactured by Wako Pure Chemical Industry, Ltd.) as a plasticizer, rose bengal (“RB” manufactured by SIGMA ALDRICH) as a sensitizing dye, 4-isopropyl-4′-methyldiphenyliodonium tetrakis(pentafluorophenyl) borate (“I0591” manufactured by Tokyo Chemical Industry Co., Ltd.) as a polymerization initiator, 2-mercaptobenzoxazole (“2-MBO” manufactured by Tokyo Chemical Industry) as a chain transfer agent, and 9,10-dibutoxyanthracene (“UVS1331” manufactured by Kawasaki Kasei Chemicals Ltd.) as an anthracene compound were mixed in an acetone solvent at room temperature to prepare a hologram recording composition 1.

### (Preparation of Hologram Recording Medium 1)

The hologram recording composition 1 was applied onto a polyvinyl alcohol film having a thickness of 2.5 μm with a bar coater so as to have a dry film thickness of 3 μm. Subsequently, a thin film surface of the photocurable resin layer was pressure-bonded onto a glass substrate having a thickness of 1.0 mm to obtain a hologram recording medium 1 formed by laminating the glass substrate, the photocurable resin layer, and the polyvinyl alcohol film in this order.

### (Preparation of Hologram 1)

The above hologram recording medium 1 was exposed to two light fluxes at an exposure amount of 156 mJ/cm² using a semiconductor laser with an exposure wavelength of 532 nm. Thereafter, the entire surface was irradiated with ultraviolet rays (UV) to cure an uncured monomer, and a refractive index distribution was fixed to the medium 1. As conditions of the exposure with two light fluxes, the exposure was performed for 30 seconds by setting the light intensity of one light flux on the recording medium to 2.6 mW/cm², and interference exposure was performed such that an angle between the two light fluxes was 3.0 degrees. As a result, a refractive index distribution was formed on the hologram recording medium 1 to obtain a hologram 1.

### (Evaluation of Hologram 1)

The refractive index modulation amount (Δn) and transparency (yellowing after UV irradiation) of the prepared hologram 1 were evaluated by the following methods.

The refractive index modulation amount (Δn) was evaluated using Kogelnik's coupled wave theory (Bell System Technical Journal, 48, 2909 (1969)) from a maximum transmittance and a half value of width of a transmittance spectrum obtained by incidence on the hologram. The transmittance spectrum was obtained by measuring a transmittance at 400 to 700 nm using a spot light source manufactured by Hamamatsu Photonics Co., Ltd. as a light source and a small fiber optical spectroscope USB-4000 manufactured by Ocean Optics Co., Ltd. as a spectroscope.

The transparency of the obtained hologram 1 was evaluated visually. In a case where yellowing was small, the transparency was evaluated to be “small”, and in a case where yellowing was large, the transparency was evaluated to be “large”.

### Examples 2 to 7

### (Preparation of Hologram Recording Compositions 2 to 7)

In Example 2, a hologram recording composition 2 was obtained according to the amounts illustrated in Table 1 in a similar manner to Example 1 using similar materials to those in Example 1 except that 1,6-hexanediol diglycidyl ether (“EX-212L” manufactured by Nagase ChemteX Corporation) was used as a plasticizer.

In Example 3, a hologram recording composition 3 was obtained according to the amounts illustrated in Table 1 in a similar manner to Example 1 using similar materials to those in Example 1 except that the amount of the anthracene-based compound was changed as illustrated in Table 1.

In Example 4, a hologram recording composition 4 was obtained according to the amounts illustrated in Table 1 in a similar manner to Example 1 using similar materials to those in Example 3 except that 1,6-hexanediol diglycidyl ether (“EX-212L” manufactured by Nagase ChemteX Corporation) was used as a plasticizer.

In Example 5, a hologram recording composition 5 was obtained according to the amounts illustrated in Table 1 in a similar manner to Example 1 using similar materials to those in Example 1 except that the amount of the anthracene-based compound was changed as illustrated in Table 1.

In Example 6, a hologram recording composition 6 was obtained according to the amounts illustrated in Table 1 in a similar manner to Example 1 using similar materials to those in Example 5 except that 1,6-hexanediol diglycidyl ether (“EX-212L” manufactured by Nagase ChemteX Corporation) was used as a plasticizer.

In Example 7, a hologram recording composition 7 was obtained according to the amounts illustrated in Table 1 in a similar manner to Example 1 using similar materials to those in Example 6 except that phenothiazine (“PT” manufactured by Wako Pure Chemical Industries, Ltd.) was used as a polymerization inhibitor.

### (Preparation of Hologram Recording Media 2 to 7)

Hologram recording media 2 to 7 were prepared in a similar manner to Example 1 using the above hologram recording compositions 2 to 7, respectively.

### (Preparation of Holograms 2 to 7)

Holograms 2 to 7 were prepared in a similar manner to Example 1 according to the exposure conditions illustrated in Table 1 using the above hologram recording media 2 to 7, respectively.

### (Evaluation of Holograms 2 to 7)

The refractive index modulation amount (Δn) and transparency (yellowing after UV irradiation) of each of the prepared holograms 2 to 7 were evaluated in a similar manner to Example 1.

Furthermore, for Examples 2, 4, 6, and 7, retention of diffraction characteristics was evaluated by the following method. The obtained holograms 2, 4, 6, and 7 were allowed to stand in an environment of 60° C. and humidity of 80% for 100 hours, and a change in the tint of diffracted light was visually evaluated. In a case where a change in the tint was not observed after the test as compared with the tint before the test, a sample was evaluated as “∘”, and in a case where a change in the tint was observed after the test as compared with the tint before the test, a sample was evaluated as “x”.

### Examples 8 to 16

### (Preparation of Hologram Recording Compositions 8 to 16)

In Example 8, a hologram recording composition 8 was obtained according to the amounts illustrated in Table 2 in a similar manner to Example 1 using similar materials to those in Example 1 except that 1,6-hexanediol diglycidyl ether (“EX-212L” manufactured by Nagase ChemteX Corporation) was used as a plasticizer, and 9,10-diethoxyanthracene (“UVS1101” manufactured by Kawasaki Kasei Chemicals Ltd.) was used as a UV sensitizer.

In Example 9, a hologram recording composition 9 was obtained according to the amounts illustrated in Table 2 in a similar manner to Example 1 using similar materials to those in Example 8 except that phenothiazine (“PT” manufactured by Wako Pure Chemical Industries, Ltd.) was used as a polymerization inhibitor.

In Example 10, a hologram recording composition 10 was obtained according to the amounts illustrated in Table 2 in a similar manner to Example 1 using similar materials to those in Example 1 except that 2-tert-butyl anthracene (manufactured by Tokyo Kasei Kogyo Co., Ltd.) was used as an anthracene-based compound.

In Example 11, a hologram recording composition 11 was obtained according to the amounts illustrated in Table 2 in a similar manner to Example 1 using similar materials to those in Example 1 except that 9-(hydroxymethyl) anthracene (manufactured by Tokyo Kasei Kogyo Co., Ltd.) was used as an anthracene-based compound.

In Example 12, a hologram recording composition 12 was obtained according to the amounts illustrated in Table 2 in a similar manner to Example 1 using similar materials to those in Example 1 except that N-phenyl-9-anthramine (manufactured by Tokyo Kasei Kogyo Co., Ltd.) was used as an anthracene-based compound.

In Example 13, a hologram recording composition 13 was obtained according to the amounts illustrated in Table 2 in a similar manner to Example 1 using similar materials to those in Example 1 except that methylene blue (“MB” manufactured by Tokyo Chemical Industry Co., Ltd.) was used as a sensitizing dye, and tetrabutylammonium=butyltriphenylborate (“P3B” manufactured by Showa Denko K.K.) was used in addition to 4-isopropyl-4′-methyldiphenyliodonium tetrakis(pentafluorophenyl) borate (“I0591” manufactured by Tokyo Chemical Industry Co., Ltd.) as a polymerization initiator.

In Example 14, a hologram recording composition 14 was obtained according to the amounts illustrated in Table 2 in a similar manner to Example 1 using similar materials to those in Example 13 except that phenothiazine (“PT” manufactured by Wako Pure Chemical Industries, Ltd.) was used as a polymerization inhibitor.

In Example 15, a hologram recording composition 15 was obtained according to the amounts illustrated in Table 2 in a similar manner to Example 1 using similar materials to those in Example 1 except that safranin ∘ (“SFO” manufactured by SIGMA ALDRICH) was used as a sensitizing dye, tetrabutylammonium=butyltriphenylborate (“P3B” manufactured by Showa Denko K.K.) was used in addition to 4-isopropyl-4′-methyldiphenyliodonium tetrakis(pentafluorophenyl) borate (“I0591” manufactured by Tokyo Chemical Industry Co., Ltd.) as a polymerization initiator, and no chain transfer agent was used.

In Example 16, a hologram recording composition 16 was obtained according to the amounts illustrated in Table 2 in a similar manner to Example 1 using similar materials to those in Example 15 except that phenothiazine (“PT” manufactured by Wako Pure Chemical Industries, Ltd.) was used as a polymerization inhibitor.

### (Preparation of Hologram Recording Media 8 to 16)

Hologram recording media 8 to 16 were prepared in a similar manner to Example 1 using the above hologram recording compositions 8 to 16, respectively.

### (Preparation of Holograms 8 to 16)

Holograms 8 to 16 were prepared in a similar manner to Example 1 according to the exposure conditions illustrated in Table 2 using the above hologram recording media 8 to 16, respectively.

### (Evaluation of Holograms 8 to 16)

The refractive index modulation amount (Δn) and transparency (yellowing after UV irradiation) of each of the prepared holograms 8 to 16 were evaluated in a similar manner to Example 1.

Furthermore, for Examples 8 and 9, retention of diffraction characteristics was evaluated in a similar manner to Examples 2, 4, 6, and 7.

### Examples 17 to 25

### (Preparation of Hologram Recording Compositions 17 to 25)

In Example 17, a hologram recording composition 17 was obtained according to the amounts illustrated in Table 3 in a similar manner to Example 1 using similar materials to those in Example 1 except that astrazon orange G (“AOG” manufactured by SIGMA ALDRICH) was used as a sensitizing dye, and tetrabutylammonium=butyltriphenylborate (“P3B” manufactured by Showa Denko K.K.) was used in addition to 4-isopropyl-4′-methyldiphenyliodonium tetrakis(pentafluorophenyl) borate (“I0591” manufactured by Tokyo Chemical Industry Co., Ltd.) as a polymerization initiator.

In Example 18, a hologram recording composition 18 was obtained according to the amounts illustrated in Table 3 in a similar manner to Example 1 using similar materials to those in Example 17 except that phenothiazine (“PT” manufactured by Wako Pure Chemical Industries, Ltd.) was used as a polymerization inhibitor.

In Example 19, a hologram recording composition 19 was obtained according to the amounts illustrated in Table 3 in a similar manner to Example 1 using similar materials to those in Example 1 except that 3,3′-diethyloxacarbocyanine iodide (“DEOCYI” manufactured by SIGMA ALDRICH) was used as a sensitizing dye, and tetrabutylammonium=butyltriphenylborate (“P3B” manufactured by Showa Denko K.K.) was used in addition to 4-isopropyl-4′-methyldiphenyliodonium tetrakis(pentafluorophenyl) borate (“I0591” manufactured by Tokyo Chemical Industry Co., Ltd.) as a polymerization initiator.

In Example 20, a hologram recording composition 20 was obtained according to the amounts illustrated in Table 3 in a similar manner to Example 1 using similar materials to those in Example 19 except that phenothiazine (“PT” manufactured by Wako Pure Chemical Industries, Ltd.) was used as a polymerization inhibitor.

In Example 21, a hologram recording composition 21 was obtained according to the amounts illustrated in Table 3 in a similar manner to Example 1 using similar materials to those in Example 1 except that polyvinyl acetate (“SN-09T” manufactured by Denka Company Limited) was used as a matrix resin, 1,6-hexanediol diglycidyl ether (“EX-212L” manufactured by Nagase ChemteX Corporation) was used as a plasticizer, and phenothiazine (“PT” manufactured by Wako Pure Chemical Industries, Ltd.) was used as a polymerization inhibitor.

In Example 22, a hologram recording composition 22 was obtained according to the amounts illustrated in Table 3 in a similar manner to Example 1 using similar materials to those in Example 21 except that polyvinyl acetate (“SN-77T” manufactured by Denka Company Limited) was used as a matrix resin.

In Example 23, a hologram recording composition 23 was obtained according to the amounts illustrated in Table 3 in a similar manner to Example 1 using similar materials to those in Example 1 except that N-vinylcarbazole (manufactured by Tokyo Chemical Industry Co., Ltd., refractive index: 1.68) was used as a radically polymerizable monomer, and phenothiazine (“PT” manufactured by Wako Pure Chemical Industries, Ltd.) was used as a polymerization inhibitor.

In Example 24, a hologram recording composition 24 was obtained according to the amounts illustrated in Table 3 in a similar manner to Example 1 using similar materials to those in Example 1 except that dinaphthothiophene methacrylate (“DNTMA” manufactured by Sugai Chemical Industry Co., Ltd., refractive index: 1.89) was used as a radically polymerizable monomer, and 1,6-hexanediol diglycidyl ether (“EX-212L” manufactured by Nagase ChemteX Corporation) was used as a plasticizer.

In Example 25, a hologram recording composition 25 was obtained according to the amounts illustrated in Table 3 in a similar manner to Example 1 using lauryl acrylate (manufactured by Tokyo Chemical Industry Co., Ltd., refractive index: 1.44) and polytetramethylene glycol diacrylate (“A-PTMG-65” manufactured by Shin-Nakamura Chemical Industry Co., Ltd., refractive index: 1.46) as radically polymerizable monomers, ZrO₂ fine particles (“SZR-K” manufactured by Sakai Chemical Industry Co., Ltd., refractive index: 2.1) as inorganic fine particles, polyvinyl acetate (“SN-55T” manufactured by Denka Company Limited) as a matrix resin, rose bengal (“RB” manufactured by SIGMA ALDRICH) as a sensitizing dye, 4-isopropyl-4′-methyldiphenyliodonium tetrakis(pentafluorophenyl) borate (“I0591” manufactured by Tokyo Chemical Industry) as a polymerization initiator, 2-mercaptobenzoxazole (“2-MBO” manufactured by Tokyo Chemical Industry Co., Ltd.) as a chain transfer agent, phenothiazine (“PT” manufactured by Wako Pure Chemical Industry Co., Ltd.) as a polymerization inhibitor, and 9,10-dibutoxyanthracene (“UVS1331” manufactured by Kawasaki Kasei Chemicals Ltd. as an anthracene-based compound.

### (Preparation of Hologram Recording Media 17 to 25)

Hologram recording media 17 to 25 were prepared in a similar manner to Example 1 using the above hologram recording compositions 17 to 25, respectively.

### (Preparation of Holograms 17 to 25)

Holograms 17 to 25 were prepared in a similar manner to Example 1 according to the exposure conditions illustrated in Table 3 using the above hologram recording media 17 to 25, respectively.

### (Evaluation of Holograms 17 to 25)

The refractive index modulation amount (Δn) and transparency (yellowing after UV irradiation) of each of the prepared holograms 17 to 25 were evaluated in a similar manner to Example 1. Furthermore, for Examples 21, 22, 24, and 25, retention of diffraction characteristics was evaluated in a similar manner to Examples 2, 4, 6, and 7.

### Test Examples 1 and 2

Preparation of a compound represented by chemical formula (6-3) (Test Example 1) as Test Example 1 and preparation of a compound represented by chemical formula (6-8) (Test Example 2) as Test Example 2 will be described.

### Test Example 1

### [Preparation of Compound Represented by Chemical Formula (6-3)]

A compound represented by the following chemical formula (6-3) was synthesized, and the compound represented by the following chemical formula (6-3) was used as a compound of Test Example 1.

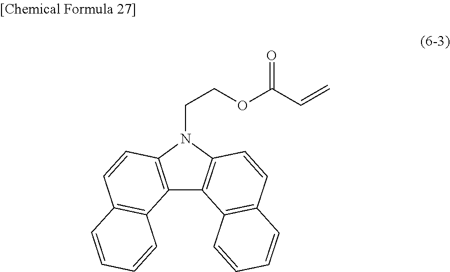 [SMILES: C=CC(=O)OCCn1c2ccc3ccccc3c2c2c3ccccc3ccc21]

### [Method for Synthesizing Compound Represented by Chemical Formula (6-3)]

A method for synthesizing the compound represented by chemical formula (6-3) (synthetic route) is as follows.

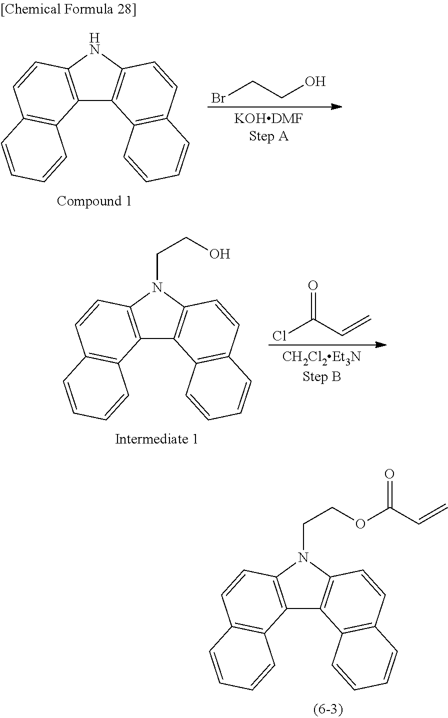

### (Step A)

Step A in the synthetic route illustrated above will be described.

Under an inert atmosphere, 110 mL of an N,N-dimethylformamide (manufactured by Kanto Chemical Co., Inc.) solution mixed with 20 g of potassium hydroxide (manufactured by Kanto Chemical Co., Inc.) was prepared, and 15 g of a compound 1 (7H-dibenzo [c,g] carbazole (manufactured by Tokyo Chemical Industry Co., Ltd.) was added thereto and stirred for one hour. Thereafter, 25 g of 2-bromoethanol (manufactured by Tokyo Chemical Industry Co., Ltd.) was added thereto to cause a reaction for 20 hours. Water was added thereto for quenching, extraction was performed with toluene using a separatory funnel, and column purification was performed to obtain 10 g of a target product (intermediate 1).

### (Step B)

Step B in the synthetic route illustrated above will be described.

In a solution obtained by mixing 6 mL of triethylamine (manufactured by Kanto Chemical Co., Inc.) with 50 mL of methylene chloride (manufactured by Kanto Chemical Co., Inc.), 9 g of an intermediate A was dissolved, and the resulting solution was cooled in an ice bath. Thereafter, 3 mL of acrylic chloride (manufactured by Tokyo Chemical Industry Co., Ltd.) was added thereto little by little, and the temperature was naturally raised to room temperature to cause a reaction for four hours. Water was added thereto for quenching, and extraction was performed with methylene chloride (manufactured by Kanto Chemical Co., Inc.) using a separatory funnel. Thereafter, the organic layer was washed with a saline solution. Silica filtration was performed, and then column purification was performed to obtain 6 g of the compound of Test Example 1 (compound represented by chemical formula (6-3)).

Using NMR, the structure of the compound of Test Example 1 (compound represented by chemical formula (6-3)) was identified. Results of NMR are as follows.

1H NMR (CDCl₃): 4.60-4.64 (2H), 4.85-4.89 (2H), 5.74-5.76 (1H), 5.95-6.05 (1H), 6.25-6.31 (1H), 7.49-7.55 (2H), 7.65-7.69 (2H), 7.70-7.77 (2H), 7.91-7.94 (2H), 8.03-8.06 (2H), 9.18-9.22 (2H)

### Test Example 2

### [Preparation of Compound Represented by Chemical Formula (6-8)]

A compound represented by the following chemical formula (6-8) was synthesized, and the compound represented by the following chemical formula (6-8) was used as a compound of Test Example 2.

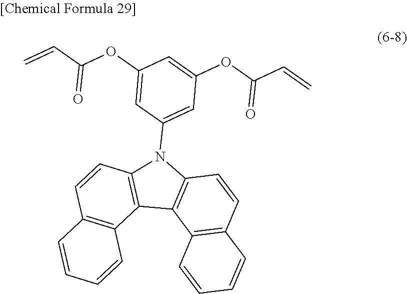 [SMILES: C=CC(=O)Oc1cc(OC(=O)C=C)cc(-n2c3ccc4ccccc4c3c3c4ccccc4ccc32)c1]

### [Method for Synthesizing Compound Represented by Chemical Formula (6-8)]

A method for synthesizing the compound represented by chemical formula (6-8) (synthetic route) is as follows.

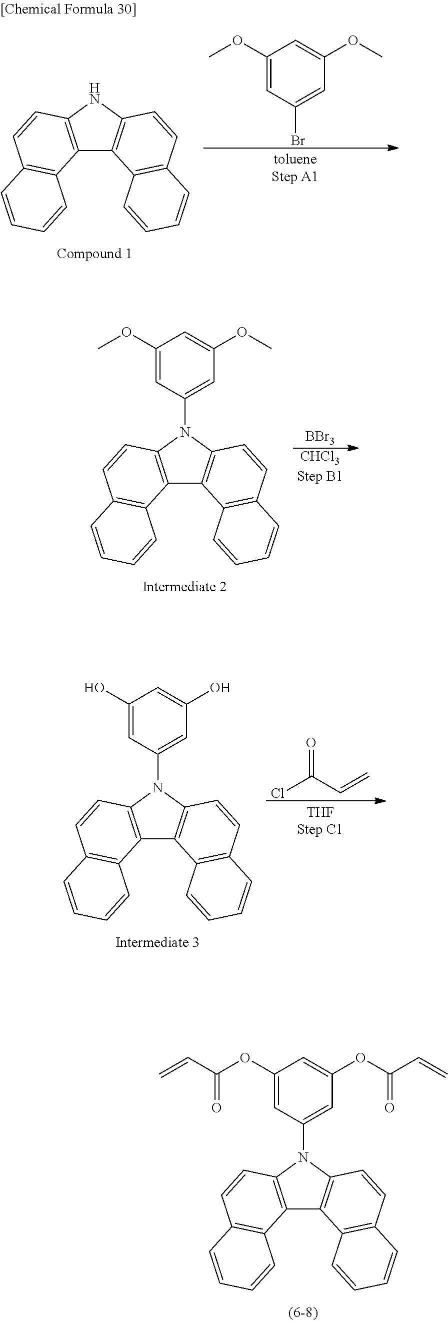

### (Step A1)

Step A1 in the synthetic route illustrated above will be described. Under an inert atmosphere, 300 mL of a toluene (manufactured by Kanto Chemical Co., Inc.) solution containing 24 g of 1-bromo-3,5-dimethoxybenzene (manufactured by Tokyo Chemical Industry Co., Ltd.), 36 g of tripotassium phosphate (manufactured by Kanto Chemical Co., Inc.), and 15 g of the compound 1 (7H-dibenzo [c,g] carbazole (manufactured by Tokyo Chemical Industry Co., Ltd.) was prepared. Thereafter, 25 mL of 1,2-cyclohexanediamine (manufactured by Tokyo Kasei Kogyo Co., Ltd.) and 20 g of copper iodide (manufactured by Wako Pure Chemical Industries, Ltd.) were added thereto, and a reaction was caused under heating and reflux to obtain 10 g of an intermediate 2.

### (Step B1)

Step B1 in the synthetic route illustrated above will be described. 9 g of the intermediate 2 was dissolved in 125 mL of chloroform (manufactured by Kanto Chemical Co., Inc.) and cooled with ice water. Thereafter, 100 mL of a dichloromethane solution (concentration 1 mol/L) in which boron tribromide was dissolved was added dropwise thereto, and the resulting mixture was stirred under ice cooling. Thereafter, a reaction was caused at room temperature for four hours. Ice water was added thereto for quenching, heptane (manufactured by Kanto Chemical Co., Inc.) was added thereto, and recrystallization was performed in a refrigerator to obtain 8 g of an intermediate 3.

### (Step C1)

Step C1 in the synthetic route illustrated above will be described. In a solution obtained by mixing 50 mL of tetrahydrofuran (manufactured by Kanto Chemical Co., Inc.), 8.5 mL of triethylamine (manufactured by Kanto Chemical Co., Inc.), and 30 mg of butylhydroxytoluene (manufactured by Tokyo Chemical Industry Co., Ltd.), 5 g of the intermediate 3 was dissolved. Thereafter, 3.5 mL of acrylic chloride (manufactured by Tokyo Chemical Industry Co., Ltd.) was added thereto little by little, and a reaction was caused at room temperature for 30 minutes. Thereafter, water was added thereto for quenching. Filtration treatment and column purification were performed to obtain 3.5 g of the compound of Test Example 2 (compound represented by chemical formula (6-8).

Using NMR, the structure of the compound of Test Example 2 (compound represented by chemical formula (6-8)) was identified. Results of NMR are as follows.

1H NMR (CDCl₃): 6.05-6.08 (2H), 6.29-6.39 (2H), 6.63-6.69 (2H), 7.25-7.27 (1H), 7.35-7.36 (2H), 7.53-7.54 (2H), 7.69-7.72 (4H), 7.86-7.90 (2H), 8.03-8.06 (2H), 9.21-9.24 (2H)

The compound (6-3) of Test Example 1 had a refractive index of 1.78. Furthermore, the compound (6-8) of Test Example 2 had a refractive index of 1.75. Note that the refractive index was measured by the following method.

An acetone solution or a chloroform solution of each of the compounds of Test Examples 1 and 2 was prepared. The average refractive index thereof with respect to light at 589 nm at room temperature 25±1° C. was measured with an Abbe refractive index meter (ER-1 manufactured by Erma Inc.). Plotting was performed for a volume fraction of each of the compounds to create a calibration curve. Note that a value determined with a dry densitometer (AccuPyc II 1340-10CC (manufactured by Shimadzu Corporation)) was used for the density of each of the compounds (Test Example 1: 1.22 g/cm³, Test Example 2: 1.31 g/cm³). The calibration curve was extrapolated, and a refractive index when the volume fraction of each of the compounds was 1 was defined as the refractive index of each of the compounds.

### Example 26

### (Preparation of Hologram Recording Composition 26)

In Example 26, a hologram recording composition 26 was obtained according to the amounts illustrated in Table 3 in a similar manner to Example 1 using similar materials to those in Example 1 except that the compound represented by chemical formula (6-3) illustrated in the above Test Example 1 (refractive index: 1.78) was used as a radically polymerizable monomer, 1,6-hexanediol diglycidyl ether (“EX-212L” manufactured by Nagase ChemteX Corporation) was used as a plasticizer, polyvinyl acetate (“SN-77T” manufactured by Denka Company Limited) was used as a matrix resin, and phenothiazine (“PT” manufactured by Wako Pure Chemical Industries, Ltd.) was used as a polymerization inhibitor.

### (Preparation of Hologram Recording Medium 26)

A hologram recording medium 26 was prepared in a similar manner to Example 1 using the above hologram recording composition 26.

### (Preparation of Hologram 26)

A hologram 26 was prepared in a similar manner to Example 1 according to the exposure conditions illustrated in Table 3 using the above hologram recording medium 26.

### (Evaluation of Hologram 26)

The refractive index modulation amount (Δn) and transparency (yellowing after UV irradiation) of the prepared hologram 26 were evaluated in a similar manner to Example 1. Furthermore, for Example 26, retention of diffraction characteristics was evaluated in a similar manner to Examples 2, 4, 6, and 7.

### Comparative Examples 1 to 8

### (Preparation of Hologram Recording Compositions 101 to 108)

In Comparative Example 1, a hologram recording composition 101 was obtained according to the amounts illustrated in Table 4 in a similar manner to Example 1 using similar materials to those in Example 1 except that no anthracene-based compound was used.

In Comparative Example 2, a hologram recording composition 102 was obtained according to the amounts illustrated in Table 4 in a similar manner to Example 1 using similar materials to those in Example 1 except that phenothiazine (“PT” manufactured by Wako Pure Chemical Industries, Ltd.) was used as a polymerization inhibitor, and no anthracene-based compound was used.

In Comparative Example 3, a hologram recording composition 103 was obtained according to the amounts illustrated in Table 4 in a similar manner to Example 1 using similar materials to those in Example 13 except that no anthracene-based compound was used.

In Comparative Example 4, a hologram recording composition 104 was obtained according to the amounts illustrated in Table 4 in a similar manner to Example 1 using similar materials to those in Example 15 except that no anthracene-based compound was used.

In Comparative Example 5, a hologram recording composition 105 was obtained according to the amounts illustrated in Table 4 in a similar manner to Example 1 using similar materials to those in Example 17 except that no anthracene-based compound was used.

In Comparative Example 6, a hologram recording composition 106 was obtained according to the amounts illustrated in Table 4 in a similar manner to Example 1 using similar materials to those in Example 19 except that no anthracene-based compound was used.

In Comparative Example 7, a hologram recording composition 107 was obtained according to the amounts illustrated in Table 4 in a similar manner to Example 1 using polyester acrylate (bifunctional, “Aronix M-6200” manufactured by Toagosei Co., Ltd., refractive index: 1.52) and ethylhexyl acrylate (manufactured by Tokyo Kasei Kogyo Co., Ltd., refractive index: 1.44) as radically polymerizable monomers, 4,4′-bis[(3-ethyloxetan-3-yl) methoxymethyl] biphenyl (“OXBP” manufactured by Ube Kosan Co., Ltd.) and bisoxylanylbenzene (“aromatic epoxy” manufactured by Nippon Steel Chemical Co., Ltd.) as plasticizers, a propylene carbonate solution (“UVI-6992” manufactured by The Dow Chemical Company) of thiobis(4,1-phenylene)-S,S,S′,S′-tetraphenyldisulfonium bishexafluorophosphate and diphenyl (4-phenylthiophenyl) sulfonium hexafluorophosphate (reduction potential: −1.06 V to −1.10 V) and bis(4-tert-butylcyclohexyl) peroxydicarbonate (“Peroyl TCP” manufactured by NOF Corporation) as polymerization initiators, and 9,10-dibutoxyanthracene (“UVS1331” manufactured by Kawasaki Kasei Chemicals Ltd.) as an anthracene-based compound.

In Comparative Example 8, a hologram recording composition 108 was obtained according to the amounts illustrated in Table 4 in a similar manner to Example 1 using bisphenoxyethanol fluorene diacrylate (“EA-0200” manufactured by Osaka Gas Chemicals Co., Ltd., refractive index: 1.62) and N-vinylcarbazole (manufactured by Tokyo Chemical Industry Co., Ltd., refractive index: 1.68) as radically polymerizable monomers, “WPI113” manufactured by Wako Pure Chemical Industries, Ltd. as a polymerization initiator, and 9,10-dibutoxyanthracene (“UVS1331” manufactured by Kawasaki Kasei Chemicals Ltd.) as an anthracene-based compound.

### (Preparation of Hologram Recording Media 101 to 108)

Hologram recording media 101 to 108 were prepared in a similar manner to Example 1 using the above hologram recording compositions 101 to 108, respectively.

### (Preparation of Holograms 101 to 108)

Holograms 101 to 108 were prepared in a similar manner to Example 1 according to the exposure conditions illustrated in Table 4 using the above hologram recording media 101 to 108, respectively.

### (Evaluation of Holograms 101 to 108)

The refractive index modulation amount (Δn) and transparency (yellowing after UV irradiation) of each of the prepared holograms 101 to 108 were evaluated in a similar manner to Example 1.

Furthermore, for Comparative Examples 1 to 7, retention of diffraction characteristics was evaluated in a similar manner to Examples 2, 4, 6, and 7.

### <Experimental Results>

Tables 1 to 4 illustrate experimental results of the holograms in Examples 1 to 26 and Comparative Examples 1 to 8 described above. Note that in Tables 1 to 4, the numerical values of the components are illustrated in terms of % by mass.

TABLE 1

| | | Example | Example | Example | Example | Example | Example | Example |
|---|---|---|---|---|---|---|---|---|
| | | 1 | 2 | 3 | 4 | 5 | 6 | 7 |
| Composition | Radically polymerizable monomer | | | | | | | |
| | EA-0200 | 36.8 | 36.8 | 36.8 | 36.8 | 36.8 | 36.8 | 36.8 |
| | EACz | 8.2 | 8.2 | 8.2 | 8.2 | 8.2 | 8.2 | 8.2 |
| | Matrix resin | | | | | | | |
| | SN-55T | 19.38 | 19.38 | 19.38 | 19.38 | 19.38 | 19.38 | 19.38 |
| | Plasticizer | | | | | | | |
| | SDE | 30 | — | 30 | — | 30 | — | — |
| | EX212L | — | 30 | — | 30 | — | 30 | 30 |
| | Sensitizing dye | | | | | | | |
| | RB | 2.25 | 2.25 | 2.25 | 2.25 | 2.25 | 2.25 | 2.25 |
| | Polymerization initiator | | | | | | | |
| | I0591 | 8.43 | 8.43 | 8.43 | 8.43 | 8.43 | 8.43 | 8.43 |
| | Chain transfer agent | | | | | | | |
| | 2-MBO | 0.56 | 0.56 | 0.56 | 0.56 | 0.56 | 0.56 | 0.56 |
| | Polymerization inhibitor | | | | | | | |
| | PT | — | — | — | — | — | — | 0.152 |
| | Anthracene-based compound | | | | | | | |
| | UVS1331 | 0.7 | 0.7 | 1.35 | 1.35 | 2.67 | 2.67 | 2.67 |
| Exposure | Wavelength [nm] | 532 | 532 | 532 | 532 | 532 | 532 | 532 |
| condition | | | | | | | | |
| Evaluation | Refractive index modulation amount (Δn) | 0.035 | 0.035 | 0.04 | 0.04 | 0.05 | 0.05 | 0.06 |
| | Yellowing after UV irradiation | Small | Small | Small | Small | Small | Small | Small |
| | Retention of diffraction | — | ∘ | — | ∘ | — | ∘ | ∘ |
| | characteristics | | | | | | | |

TABLE 2

| | | Example | Example | Example | Example | Example | Example | Example | Example | Example |
|---|---|---|---|---|---|---|---|---|---|---|
| | | 8 | 9 | 10 | 11 | 12 | 13 | 14 | 15 | 16 |
| Composition | Radically polymerizable monomer | | | | | | | | | |
| | EA-0200 | 36.8 | 36.8 | 36.8 | 36.8 | 36.8 | 36.8 | 36.8 | 36.8 | 36.8 |
| | EACz | 8.2 | 8.2 | 8.2 | 8.2 | 8.2 | 8.2 | 8.2 | 8.2 | 8.2 |
| | Matrix resin | | | | | | | | | |
| | SN-55T | 19.38 | 19.38 | 19.38 | 19.38 | 19.38 | 19.38 | 19.38 | 19.38 | 19.38 |
| | Plasticizer | | | | | | | | | |
| | SDE | — | — | 30 | 30 | 30 | 30 | 30 | 30 | 30 |
| | EX212L | 30 | 30 | — | — | — | — | — | — | — |
| | Sensitizing dye | | | | | | | | | |
| | RB | 2.25 | 2.25 | 2.25 | 2.25 | 2.25 | — | — | — | — |
| | MB | — | — | — | — | — | 1.88 | 1.88 | — | — |
| | SFO | — | — | — | — | — | — | — | 0.23 | 0.23 |
| | Polymerization initiator | | | | | | | | | |
| | I0591 | 8.43 | 8.43 | 8.43 | 8.43 | 8.43 | 5.97 | 5.97 | 11.94 | 11.94 |
| | P3B | — | — | — | — | — | 3.18 | 3.18 | 3.18 | 3.18 |
| | Chain transfer agent | | | | | | | | | |
| | 2-MBO | 0.56 | 0.56 | 0.56 | 0.56 | 0.56 | 0.14 | 0.14 | — | — |
| | Polymerization inhibitor | | | | | | | | | |
| | PT | — | 0.152 | — | — | — | — | 0.22 | — | 0.22 |
| | Anthracene-based compound | | | | | | | | | |
| | UVS1331 | — | — | — | — | — | 7.76 | 7.76 | 7.76 | 7.76 |
| | UVS1101 | 2.67 | 2.67 | — | — | — | — | — | — | — |
| | 2-tert-butyl anthracene | — | — | 0.7 | — | — | — | — | — | — |
| | 9-hydroxymethyl anthracene | — | — | — | 0.7 | — | — | — | — | — |
| | N-phenyl-9-anthramine | — | — | — | — | 0.7 | — | — | — | — |
| Exposure | Wavelength [nm] | 532 | 532 | 532 | 532 | 532 | 660 | 660 | 532 | 532 |
| condition | | | | | | | | | | |
| Evaluation | Refractive index modulation amount | 0.05 | 0.06 | 0.035 | 0.035 | 0.035 | 0.05 | 0.06 | 0.04 | 0.05 |
| | (Δn) | | | | | | | | | |
| | Yellowing after UV irradiation | Small | Small | Small | Small | Small | Small | Small | Small | Small |
| | Retention of diffraction | ∘ | ∘ | — | — | — | — | — | — | — |
| | characteristics | | | | | | | | | |

TABLE 3

| | | Example | Example | Example | Example | Example | Example | Example | Example | Example | Example |
|---|---|---|---|---|---|---|---|---|---|---|---|
| | | 17 | 18 | 19 | 20 | 21 | 22 | 23 | 24 | 25 | 26 |
| Composition | Radically polymerizable | | | | | | | | | | |
| | monomer | | | | | | | | | | |
| | EA-0200 | 36.8 | 36.8 | 36.8 | 36.8 | 36.8 | 36.8 | 36.8 | 36.8 | — | 36.8 |
| | EACz | 8.2 | 8.2 | 8.2 | 8.2 | 8.2 | 8.2 | — | — | — | — |
| | N-vinylcarbazole | — | — | — | — | — | — | 8.2 | — | — | — |
| | DNTMA | — | — | — | — | — | — | — | 11.8 | — | — |
| | Compound represented by | — | — | — | — | — | — | — | — | — | 8.2 |
| | chemical formula (6-3) | | | | | | | | | | |
| | Lauryl acrylate | — | — | — | — | — | — | — | — | 3.5 | — |
| | Polytetramethylene glycol | — | — | — | — | — | — | — | — | 15.8 | — |
| | diacrylate | | | | | | | | | | |
| | Inorganic fine particles | | | | | | | | | | |
| | SZR-K | — | — | — | — | — | — | — | — | 45 | — |
| | Matrix resin | | | | | | | | | | |
| | SN-55T | 19.38 | 19.38 | 19.38 | 19.38 | — | — | 19.38 | 19.38 | 19.38 | — |
| | SN-09T | — | — | — | — | 19.38 | — | — | — | — | — |
| | SN-77T | — | — | — | — | — | 19.38 | — | — | — | 19.38 |
| | Plasticizer | | | | | | | | | | |
| | SDE | 30 | 30 | 30 | 30 | — | — | 30 | — | — | — |
| | EX212L | — | — | — | — | 30 | 30 | — | 30 | — | 30 |
| | Sensitizing dye | | | | | | | | | | |
| | RB | — | — | — | — | 2.25 | 2.25 | 2.25 | 2.25 | 2.25 | 2.25 |
| | AOG | 2.34 | 2.34 | — | — | — | — | — | — | — | — |
| | DEOCYI | — | — | 2.34 | 2.34 | — | — | — | — | — | — |
| | Polymerization initiator | | | | | | | | | | |
| | I0591 | 8.43 | 8.43 | 8.43 | 8.43 | 8.43 | 8.43 | 8.43 | 8.43 | 8.43 | 8.43 |
| | P3B | 3.42 | 3.42 | 3.42 | 3.42 | — | — | — | — | — | — |
| | Chain transfer agent | | | | | | | | | | |
| | 2-MBO | 0.56 | 0.56 | 0.56 | 0.56 | 0.56 | 0.56 | 0.56 | 0.56 | 0.56 | 0.56 |
| | Polymerization inhibitor | | | | | | | | | | |
| | PT | — | 0.08 | — | 0.08 | 0.152 | 0.152 | 0.152 | — | 0.152 | 0.152 |
| | Anthracene-based compound | | | | | | | | | | |
| | UVS1331 | 1.39 | 1.39 | 1.39 | 1.39 | 2.67 | 2.67 | 0.1 | 0.2 | 2.67 | 2.67 |
| Exposure | Wavelength [nm] | 457 | 457 | 457 | 457 | 532 | 532 | 532 | 532 | 532 | 532 |
| condition | | | | | | | | | | | |
| Evaluation | Refractive index modulation | 0.04 | 0.05 | 0.04 | 0.05 | 0.06 | 0.06 | 0.05 | 0.07 | 0.07 | 0.06 |
| | amount (Δn) | | | | | | | | | | |
| | Yellowing after UV | Small | Small | Small | Small | Small | Small | Small | Small | Small | Small |
| | irradiation | | | | | | | | | | |
| | Retention of diffraction | — | — | — | — | ∘ | ∘ | — | ∘ | ∘ | ∘ |
| | characteristics | | | | | | | | | | |

TABLE 4

| | | Comparative | Comparative | Comparative | Comparative | Comparative | Comparative | Comparative | Comparative |
|---|---|---|---|---|---|---|---|---|---|
| | | Example 1 | Example 2 | Example 3 | Example 4 | Example 5 | Example 6 | Example 7 | Example 8 |
| Composition | Radically | | | | | | | | |
| | polymerizable | | | | | | | | |
| | monomer | | | | | | | | |
| | EA-0200 | 36.8 | 36.8 | 36.8 | 36.8 | 36.8 | 36.8 | — | 50 |
| | Aronix M-6200 | — | — | — | — | — | — | 58.6 | — |
| | EACz | 8.2 | 8.2 | 8.2 | 8.2 | 8.2 | 8.2 | — | — |
| | N-vinylcarbazole | — | — | — | — | — | — | — | 50 |
| | Ethylhexyl acrylate | — | — | — | — | — | — | 25.1 | — |
| | Matrix resin | | | | | | | | |
| | SN-55T | 19.38 | 19.38 | 19.38 | 19.38 | 19.38 | 19.38 | — | — |
| | Plasticizer | | | | | | | | |
| | SDE | 30 | 30 | 30 | 30 | 30 | 30 | — | — |
| | OXBP | — | — | — | — | — | — | 7.5 | — |
| | Aromatic epoxy | — | — | — | — | — | — | 4.5 | — |
| | Sensitizing dye | | | | | | | | |
| | RB | 2.25 | 2.25 | — | — | — | — | — | — |
| | MB | — | — | 1.88 | — | — | — | — | — |
| | SFO | — | — | — | 0.23 | — | — | — | — |
| | AOG | — | — | — | — | 2.34 | — | — | — |
| | DEOCYI | — | — | — | — | — | 2.34 | — | — |
| | Polymerization | | | | | | | | |
| | initiator | | | | | | | | |
| | I0591 | 8.43 | 8.43 | 5.97 | 11.94 | 8.43 | 8.43 | — | — |
| | WPI113 | — | — | — | — | — | — | — | 5 |
| | UVI-6992 | — | — | — | — | — | — | 3 | — |
| | P3B | — | — | 3.18 | 3.18 | 3.42 | 3.42 | — | — |
| | Peroyl TCP | — | — | — | — | — | — | 1 | — |
| | Chain transfer | | | | | | | | |
| | agent | | | | | | | | |
| | 2-MBO | 0.56 | 0.56 | 0.14 | — | 0.56 | 0.56 | — | — |
| | Polymerization | | | | | | | | |
| | inhibitor | | | | | | | | |
| | PT | — | 0.152 | — | — | — | — | — | — |
| | Anthracene-based | | | | | | | | |
| | compound | | | | | | | | |
| | UVS1331 | — | — | — | — | — | — | 0.3 | 1.5 |
| | Viscosity adjusting | | | | | | | | |
| | agent | | | | | | | | |
| | Ethylene- | — | — | — | — | — | — | — | 1 |
| | methylphenyl | | | | | | | | |
| | norbornene | | | | | | | | |
| | copolymer | | | | | | | | |
| | Leveling agent | | | | | | | | |
| | Disparlon 1761 | — | — | — | — | — | — | — | 2.5 |
| Exposure | Wavelength [nm] | 532 | 532 | 660 | 532 | 457 | 457 | 405 | 250 |
| condition | | | | | | | | | |
| Evaluation | Refractive index | 0.03 | 0.04 | 0.03 | 0.03 | 0.03 | 0.03 | <0.02 | <0.01 |
| | modulation amount | | | | | | | | |
| | (Δn) | | | | | | | | |
| | Yellowing after | Large | Large | Large | Large | Large | Large | Small | Small |
| | UV irradiation | | | | | | | | |
| | Retention of | x | x | x | x | x | x | ∘ | — |
| | diffraction | | | | | | | | |
| | characteristics | | | | | | | | |

Tables 1 to 4 indicate that by combination of the radically polymerizable monomer, the matrix resin, the photopolymerization initiator, and the anthracene-based compound, a hologram having a high refractive index modulation amount (Δn) can be obtained without going through a heating step after exposure. Furthermore, the obtained hologram has small yellowing after UV irradiation and has favorable transparency.

Furthermore, it has been found that use of an epoxy compound or an oxetane compound, which is a cationically polymerizable compound, as a plasticizer also improves retention of the diffraction characteristics. Note that in hologram 26, a hologram obtained by replacing a part of EA-0200 with the compound represented by chemical formula (6-8) is considered to have small yellowing after UV irradiation and favorable transparency.

As described above, according to the present technology, by combination of the radically polymerizable monomer, the matrix resin, the photopolymerization initiator, and the anthracene-based compound, a hologram having excellent diffraction characteristics can be obtained without going through a heating step after exposure.

### REFERENCE SIGNS LIST

1 Hologram recording medium
11 Transparent protective film (transparent base material)
12 Photocurable resin layer
13 Glass or film substrate (transparent base material)

1. A hologram recording composition comprising at least a radically polymerizable monomer, a matrix resin, a photopolymerization initiator, and an anthracene-based compound.

2. The hologram recording composition according to claim 1, comprising a monofunctional monomer and a polyfunctional monomer as the radically polymerizable monomer.

3. The hologram recording composition according to claim 1, wherein the radically polymerizable monomer has a refractive index of 1.6 or more.

4. The hologram recording composition according to claim 1, wherein the radically polymerizable monomer is at least one selected from the group consisting of a carbazole-based monomer, a fluorene-based monomer, and a dinaphthothiophene-based monomer.

5. The hologram recording composition according to claim 1, wherein the radically polymerizable monomer is a compound represented by the following general formula (1-10). 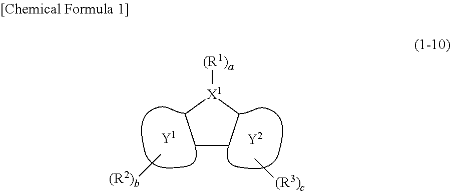
(In the general formula (1-10), X¹ is an oxygen atom, a nitrogen atom, a phosphorus atom, a carbon atom, or a silicon atom. In a case where X¹ is an oxygen atom, a is 0. In a case where X¹ is a nitrogen atom or a phosphorus atom, a is 1. In a case where X¹ is a carbon atom or a silicon atom, a is 2.
Y¹ and Y² are each a benzene ring or a naphthalene ring, and Y¹ and Y² are not both benzene rings at the same time. In a case where Y¹ or Y² is a benzene ring, b or c corresponding to the benzene ring Y¹ or Y² is 4. In a case where Y¹ and/or Y² is a naphthalene ring, b and/or c corresponding to the naphthalene ring Y¹ and/or Y² is 6.
R¹ to R³ are each a hydrogen atom or a substituent represented by *—Z¹(R⁴)_{d} (* represents a bond position). In a case where a plurality of R¹s, a plurality of R²s, and a plurality of R³s are present, the plurality of R¹s to R³s may be the same as or different from each other. However, R¹s to R³s in the general formula (1-10) are not all hydrogen atoms at the same time.
Z¹ represents a single bond, a divalent or higher valent saturated hydrocarbon group, or a divalent or higher valent unsaturated hydrocarbon group, and the saturated hydrocarbon group or the unsaturated hydrocarbon group may contain an ether bond and/or a thioether bond. In a case where Z¹ is a single bond, d is 1. In a case where Z¹ is a saturated hydrocarbon group or an unsaturated hydrocarbon group, d is an integer equal to or larger than 1.
R⁴ represents a hydrogen atom or a polymerizable substituent. In a case where a plurality of R⁴s is present, the plurality of R⁴s may be the same as or different from each other. However, R⁴s in the general formula (1-10) are not all hydrogen atoms at the same time.)

6. The hologram recording composition according to claim 1, further comprising inorganic fine particles.

7. The hologram recording composition according to claim 1, further comprising a cationically polymerizable compound.

8. The hologram recording composition according to claim 1, wherein the cationically polymerizable compound is at least one selected from the group consisting of an epoxy compound and an oxetane compound.

9. The hologram recording composition according to claim 1, further comprising a polymerization inhibitor.

10. A hologram recording medium comprising a photocurable resin layer containing at least a radically polymerizable monomer, a matrix resin, a photopolymerization initiator, and an anthracene-based compound.

11. The hologram recording medium according to claim 10, comprising a monofunctional monomer and a polyfunctional monomer as the radically polymerizable monomer.

12. The hologram recording medium according to claim 10, wherein the radically polymerizable monomer has a refractive index of 1.6 or more.

13. The hologram recording medium according to claim 10, wherein the radically polymerizable monomer is at least one selected from the group consisting of a carbazole-based monomer, a fluorene-based monomer, and a dinaphthothiophene-based monomer.

14. The hologram recording medium according to claim 10, wherein the radically polymerizable monomer is a compound represented by the following general formula (1-10). 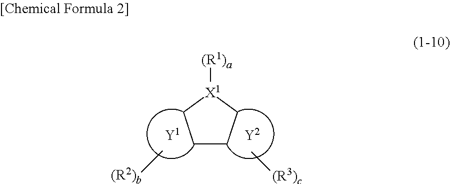
(In the general formula (1-10), X¹ is an oxygen atom, a nitrogen atom, a phosphorus atom, a carbon atom, or a silicon atom. In a case where X¹ is an oxygen atom, a is 0. In a case where X¹ is a nitrogen atom or a phosphorus atom, a is 1. In a case where X¹ is a carbon atom or a silicon atom, a is 2.
Y¹ and Y² are each a benzene ring or a naphthalene ring, and Y¹ and Y² are not both benzene rings at the same time. In a case where Y¹ or Y² is a benzene ring, b or c corresponding to the benzene ring Y¹ or Y² is 4. In a case where Y¹ and/or Y² is a naphthalene ring, b and/or c corresponding to the naphthalene ring Y¹ and/or Y² is 6.
R¹ to R³ are each a hydrogen atom or a substituent represented by *—Z¹(R⁴)_{d} (* represents a bond position). In a case where a plurality of R¹s, a plurality of R²s, and a plurality of R³s are present, the plurality of R¹s to R³s may be the same as or different from each other. However, R¹s to R³s in the general formula (1-10) are not all hydrogen atoms at the same time.
Z¹ represents a single bond, a divalent or higher valent saturated hydrocarbon group, or a divalent or higher valent unsaturated hydrocarbon group, and the saturated hydrocarbon group or the unsaturated hydrocarbon group may contain an ether bond and/or a thioether bond. In a case where Z¹ is a single bond, d is 1. In a case where Z¹ is a saturated hydrocarbon group or an unsaturated hydrocarbon group, d is an integer equal to or larger than 1.
R⁴ represents a hydrogen atom or a polymerizable substituent. In a case where a plurality of R⁴s is present, the plurality of R⁴s may be the same as or different from each other. However, R⁴s in the general formula (1-10) are not all hydrogen atoms at the same time.)

15. The hologram recording medium according to claim 10, further comprising inorganic fine particles.

16. The hologram recording medium according to claim 10, further comprising a cationically polymerizable compound.

17. The hologram recording medium according to claim 10, wherein the cationically polymerizable compound is at least one selected from the group consisting of an epoxy compound and an oxetane compound.

18. The hologram recording medium according to claim 10, further comprising a polymerization inhibitor.

19. A hologram using the hologram recording medium according to claim 10.

20. The hologram according to claim 19, having absorption derived from an anthracene skeleton.

21. An optical device using the hologram according to claim 19.

22. An optical component using the hologram according to claim 19.
